(19) United States
(12) Patent Application Publication
(10) Pub. No.: US 2012/0319637 A1
(43) Pub. Date: Dec. 20, 2012

(54) Synchronization control devices and methods

(75) Inventors: Pai-Hsueh Yang, Belmont, CA (US); Kazuhiro Hirano, Saitama (JP); Masao Yuasa, Tokyo (JP)

(73) Assignee: Nikon Corporation

(21) Appl. No.: 13/317,982

(22) Filed: Oct. 31, 2011

Related U.S. Application Data
(60) Provisional application No. 61/498,940, filed on Jun. 20, 2011.

(51) Int. Cl. G05B 13/02; G05B 11/32

(52) U.S. Cl. 318/561; 318/625

(57) ABSTRACT

Control systems are disclosed that control motion of a first movable body along a first trajectory in coordination with motion of a second movable body along a second trajectory. An exemplary system has first and second controllers. The first controller provides first driving commands to the first movable body. The second controller provides second driving commands to the second movable body. A first control loop associated with the first controller includes feedback to the first controller of position-error data regarding the first movable body. A second control loop associated with the second controller includes feedback to the second controller of position-error data regarding the second movable body. A synchronization target filter couples the first and second control loops and causes the first controller to move the first movable body in a manner that tracks the position-error data of the second movable body at one or more frequencies of interest.

### CROSS-REFERENCE TO RELATED APPLICATION

This application claims priority to and the benefit of U.S. Provisional Patent Application No. 61/498,940, filed on Jun. 20, 2011, which is incorporated herein by reference in its entirety.

### FIELD

This disclosure pertains to, inter alia, positioning apparatus as used in high-precision systems for placing an object at a desired location at which a process is conducted on, to, or relative to the object. More specifically, the disclosure pertains to control systems for controlling actuation of one or more actuators to move a stage on which an object such as a semiconductor wafer or pattern-defining reticle is mounted.

### BACKGROUND

In modern projection microlithography systems, the respective motions of the reticle stage and of the substrate stage must be very precisely controlled. One reason for such strict control is the extreme accuracy with which pattern images are transferred from the reticle to the lithographic substrate (e.g., semiconductor wafer). Accurate image transfer requires accurate and precise coordination of the movements of the reticle and of the substrate relative to each other. In other words, the motions of the reticle stage and substrate stage must be synchronized so that the right image as defined on the reticle is projected onto the right location on the substrate in minimal time.

Achieving satisfactory synchronization of the substrate and reticle stages is difficult due to extraneous motions and vibrations of the stages, including motions and vibrations of one stage that are not experienced by the other stage. Reducing these extraneous motions to achieve better control of stage position requires sophisticated control methods. These control methods include feedback control and feed-forward control. Iterative learning control (ILC) has been utilized in combination with feedback control, and these combinations have produced some improvements. Feedback-control systems typically include closed-loop control. Since these control schemes have evolved to contend with progressively finer variations and oscillations of positional errors of the reticle stage and substrate stage, they have become extremely complex.

To compensate for substrate-error oscillations exhibited by the reticle stage, a peak filter (i.e., a so-called adaptive feed-forward canceler, or AFC) may be applied to the feedback control of the reticle stage. This effectively places the AFC inside the reticle-stage closed loop. Unfortunately, the feasible compensation frequencies and effectiveness of such a control system are limited by system-stability issues and performance deterioration that are evident at certain frequencies, for example 250 Hz. Generally, the lower the frequency (i.e., lower than the reticle-stage bandwidth) to which AFC is applied, the better the performance that can be achieved. However, conventional control schemes including AFC have not yet achieved the strict control now demanded by the latest microlithography equipment and processes. One source of the problem of deterioration of synchronization error at some frequencies is substrate-error variations that cannot be effectively compensated by iterative learning control (ILC).

Therefore, there remains a problem of synchronization-error deterioration at some frequencies due to substrate-error variations for which ILC cannot effectively compensate.

### SUMMARY

The above-noted problem is addressed herein by a control system including a synchronization target filter having a configuration based upon reticle-stage closed-loop dynamics, which enables the reticle stage to track for substrate error at frequencies of interest. The control systems including a frequency-selected target filter effectively compensate for substrate error at multiple frequencies (which can be within or outside the reticle-stage feedback-control bandwidth). By desirably locating the control system outside the reticle-stage feedback loop, instability of the reticle-stage system is avoided.

An exemplary embodiment of the control system is applied to, for example, controlling motion of a first movable body along a first trajectory in coordination with motion of a second movable body along a second trajectory. Such a control system comprises first and second controllers. The first controller provides first driving commands to the first movable body. The second controller provides second driving commands to the second movable body. A first control loop is associated with the first controller and provides feedback to the first controller of position-error data regarding the first movable body. A second control loop is associated with the second controller and provides feedback to the second controller of position-error data regarding the second movable body. The control system further comprises a synchronization target filter coupling the second control loop to the first control loop. The target filter allows the first controller to move the first movable body in a manner that tracks the position-error data of the second movable body at one or more frequencies of interest.

Desirably, the synchronization target filter couples the second control loop outside the first control loop.

The control system in some embodiments further comprises a first iterative learning controller connected to the first control loop. In other embodiments, the control system further comprises a second iterative learning controller that is connected to the second control loop. In yet other embodiments the control system further comprises a first iterative learning controller associated with the first control loop, and a second iterative learning controller associated with the second control loop. The first iterative learning controller includes an input connected to an output of the first control loop and an output connected to the first control loop, the second control loop is a closed loop, and the second iterative learning controller is connected to the second control loop. In these configurations a first feedback filter can be connected between the first controller and the connection of the first iterative learning controller to the first control loop, and a second feedback filter can be connected between the first controller and the connection of the second iterative learning controller to the second closed loop.

In embodiments in which the first control loop is a closed loop, the synchronization target filter can be connected between the second iterative learning controller and the first control loop. If the second control loop is a closed loop, the first iterative learning controller can include an input connected to an output of the first control loop and an output connected to the first control loop, and the second iterative learning controller can be connected to the second control loop.

The second iterative learning controller can be configured to learn the synchronization error of the second movable body relative to the first movable body.

The synchronization target filter desirably includes a phase lead filter and at least one notch filter for a respective frequency of interest. In these embodiments at least one notch filter of the target filter desirably is an active filter. If the target filter includes multiple notch filters, at least one notch filter can be passive. If the synchronization target filter includes n notch filters, wherein n is an integer, each notch filter desirably corresponds to a respective frequency of interest. In addition, if n≧2, at least one respective notch filter can be active and at least one respective notch filter can be passive.

In certain embodiment of the control system, the synchronization target filter has a cost function of synchronization-error MA (moving average) and MSD (moving standard deviation).

The foregoing and additional features and advantages of the invention will be more apparent from the detailed description, which proceeds with reference to the accompanying drawings.

### BRIEF DESCRIPTION OF THE DRAWINGS

FIG. 1A is a control diagram of an embodiment of a system for controlling synchrony of reticle position and wafer position, the system including a target filter for the reticle stage but situated outside the reticle-stage closed loop. Feed-forward control is omitted from the figure for simplicity.

FIG. 1B is a diagram of a synchronization target filter including a phase lead filter and n notch filters.

FIGS. 2A, 2B, and 2C are simulated frequency responses of the target filter (FIG. 2A), synchronization transfer function (FIG. 2B), and synchronization sensitivity (FIG. 2C). FIGS. 2B and 2C show data without the target filter (“default”) and with the target filter.

FIGS. 3A-3D are plots of simulation data (250-Hz notch) pertaining to synch error, synch MA, synch MSD, and synch error FFT without the target filter being present.

FIGS. 3E-3H are plots of simulation data (250-Hz notch) pertaining to synch error, synch MA, synch MSD, and synch error FFT obtained with target filter #1 being present.

FIGS. 4A-4D are plots of simulation data (230-Hz notch) pertaining to synch error, synch MA, synch MSD, and synch error FFT obtained with target filter #2 being present.

FIGS. 5A-5C are frequency plots comparing target filters #1 and #2, including synchronization transfer function and synchronization sensitivity.

FIGS. 6A-6C are frequency plots comparing synchronization sensitivity of a two-frequency target filter, compared to a default situation (no target filter present), configured according to Equations (12A), (12A) and (12B), and (12A)-(12C), respectively.

FIG. 7 is a control diagram pertaining to a simulation in which no ILC is used and a target notch filter is used to compensate for wafer-error variations.

FIGS. 8A-8D are plots of cost-function history, lead-filter parameter history, notch-filter #1 parameter history, and notch-filter #2 parameter history, respectively.

FIGS. 9A-9D are plots of synchronization accuracy for X synch error, X synch MA, X synch MSD, and X synch error FFT, respectively, in a default (no target filter) situation.

FIGS. 10A-10D are plots of synchronization accuracy for X synch error, X synch MA, X synch MSD, and X synch error FFT, respectively, with an initial target filter (no learning iterations yet performed).

FIGS. 11A-11D are plots of synchronization accuracy for X synch error, X synch MA, X synch MSD, and X synch error FFT, respectively, for an optimized result after 100 Simplex iterations, where β=0.05.

FIGS. 12A and 12B are frequency plots of the synchronization transfer function and synchronization sensitivity, respectively, summarizing the data in FIGS. 8-11.

FIGS. 13A-13D are plots of synchronization accuracy after 100 Simplex iterations for X synch error, X synch MA, X synch MSD, and X synch error FFT, respectively, with an MSD weighting of β=0.01.

FIGS. 14A-14D are plots of synchronization accuracy after 100 Simplex iterations for X synch error, X synch MA, X synch MSD, and X synch error FFT, respectively, with an MSD weighting of β=0.05.

FIGS. 15A-15D are plots of synchronization accuracy after 100 Simplex iterations for X synch error, X synch MA, X synch MSD, and X synch error FFT, respectively, with an MSD weighting of β=0.1.

FIGS. 16A-16D are plots of synchronization accuracy after 100 Simplex iterations for X synch error, X synch MA, X synch MSD, and X synch error FFT, respectively, with an MSD weighting of β=0.2.

FIGS. 17A-17D are plots of synchronization accuracy after 100 Simplex iterations for X synch error, X synch MA, X synch MSD, and X synch error FFT, respectively, with an MSD weighting of β=0.4.

FIG. 18A is a plot of maximal MA and MSD versus MSD weighting after 100 Simplex iterations.

FIG. 18B is a plot of average MA and MSD versus MSD weighting after 100 Simplex iterations.

FIG. 19A is a plot of cost function history per iteration, where β=0.01.

FIGS. 19B-19D are plots of target filter parameter history per iteration, where β=0.01.

FIG. 20A is a plot of cost function history per iteration, where β=0.05.

FIGS. 20B-20D are plots of target filter parameter history per iteration, where β=0.05.

FIG. 21A is a plot of cost function history per iteration, where β=0.1.

FIGS. 21B-21D are plots of target filter parameter history per iteration, where β=0.1.

FIG. 22A is a plot of cost function history per iteration, where β=0.2.

FIGS. 22B-22D are plots of target filter parameter history per iteration, where β=0.2.

FIG. 23A is a plot of cost function history per iteration, where β=0.4.

FIGS. 23B-23D are plots of target filter parameter history per iteration, where β=0.4.

FIGS. 24A-24C are plots of converged target filter parameters as functions of MSD weighting after 100 Simplex iterations.

FIG. 25A is a frequency plot of synch transfer function with various MSD weights after 100 Simplex iterations.

FIG. 25B is a frequency plot of synch sensitivity with various MSD weights after 100. Simplex iterations.

FIG. 26A is a control diagram for a simulation of the target filter and reticle X-position closed loop.

FIG. 26B is a control diagram for a simulation of the wafer X-position closed loop model with measurement noise.

FIGS. 27A-27D are plots of measured wafer X-position error, wafer X-position error MA, wafer X-position error MSD, and wafer X-position error FFT, respectively.

FIGS. 28A-28D are plots of actual wafer X-position error, wafer X-position error MA, wafer X-position error MSD, and wafer X-position error FFT, respectively.

FIGS. 29A-29B are frequency plots of the WX closed-loop transfer function and of WX sensitivity, respectively.

FIGS. 30A-30D are frequency plots of the synch transfer functions for active second and third notches, passive second notch and active third notch, active second notch and passive third notch, and passive second and third notches, respectively.

FIGS. 30E-30H are frequency plots of the synch sensitivity functions for active second and third notches, passive second notch and active third notch, active second notch and passive third notch, and passive second and third notches, respectively.

FIGS. 31A-31D are frequency plots of the averaged MA and MSD versus MSD weighting for active second and third notches, passive second notch and active third notch, active second notch and passive third notch, and passive second and third notches, respectively.

FIGS. 31E-31H are frequency plots of the maximum MA and MSD versus MSD weighting for active second and third notches, passive second notch and active third notch, active second notch and passive third notch, and passive second and third notches, respectively.

FIG. 32 is a schematic diagram of an immersion microlithography system, which is an example of a precision system including a synchronization control system as described herein.

FIG. 33 is a schematic diagram of an extreme-UV microlithography system which is a second example of a precision system including a synchronization control system as described herein.

FIG. 34 is a process-flow diagram depicting exemplary steps associated with a process for fabricating semiconductor devices.

FIG. 35 is a process-flow diagram depicting exemplary steps associated with a processing a substrate (e.g., a wafer), as would be performed, for example, in step 704 in the process shown in FIG. 34.

### DETAILED DESCRIPTION

This disclosure is set forth in the context of representative embodiments that are not intended to be limiting in any way.

The drawings are intended to illustrate the general manner of construction and are not necessarily to scale. In the detailed description and in the drawings themselves, specific illustrative examples are shown and described herein in detail. It will be understood, however, that the drawings and the detailed description are not intended to limit the invention to the particular forms disclosed, but are merely illustrative and intended to teach one of ordinary skill how to make and/or use the invention claimed herein.

As used in this application and in the claims, the singular forms “a,” “an,” and “the” include the plural forms unless the context clearly dictates otherwise. Additionally, the term “includes” means “comprises.” Further, the term “coupled” encompasses mechanical as well as other practical ways of coupling or linking items together, and does not exclude the presence of intermediate elements between the coupled items.

The described things and methods described herein should not be construed as being limiting in any way. Instead, this disclosure is directed toward all novel and non-obvious features and aspects of the various disclosed embodiments, alone and in various combinations and sub-combinations with one another. The disclosed things and methods are not limited to any specific aspect or feature or combinations thereof, nor do the disclosed things and methods require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and method. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In the following description, certain terms may be used such as “up,” “down,”, “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

The problem of deterioration of synchronization error at some frequencies due to wafer-error variations for which ILC cannot effectively compensate is solved by various aspects of the invention. At least one aspect is directed to a control system that includes a synchronization target filter that exploits reticle-stage closed-loop dynamics. This allows the reticle stage to track wafer error extremely well at the frequencies of interest.

Since the target filter is implemented outside the reticle-stage closed-loop, closed-loop stability is not a constraint, and stage control is effective at least in frequencies of interest. The target filter comprises at least one notch filter and at least one phase-lead filter. Implementation of the target filter is simple. The target filter effectively treats synchronization errors with and without obvious peak frequencies (e.g., associated with X versus Y axes of movement). Optimization of target-filter parameters has been achieved using a cost function of the synchronization error MA (moving average) and MSD (moving standard deviation).

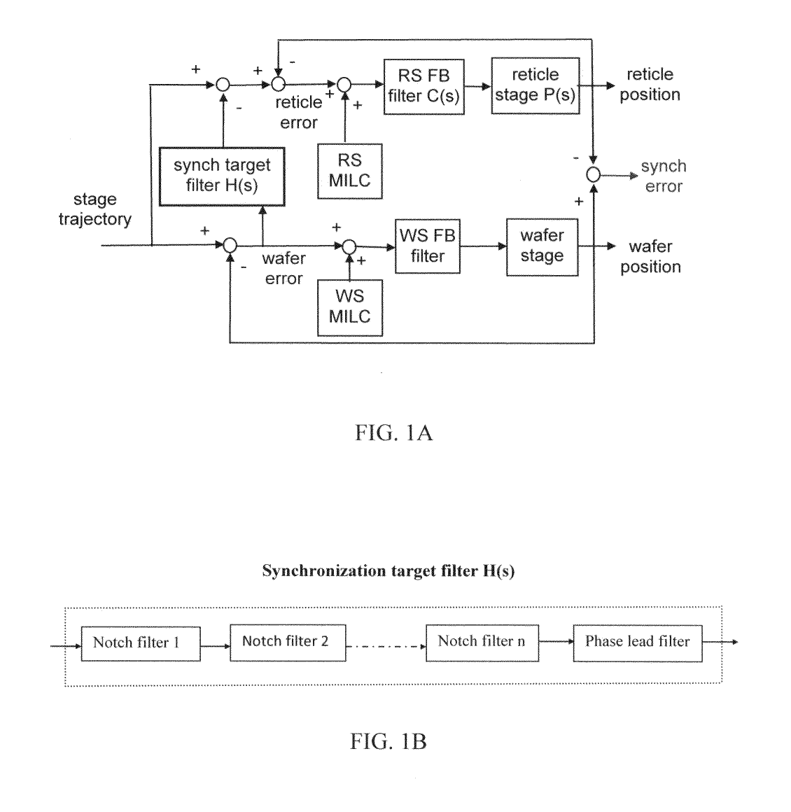

FIG. 1A depicts an embodiment of a control system, directed particularly to controlling motion of a reticle stage (as an exemplary second movable body) based on motion of a wafer stage (as an exemplary first movable body). The control system comprises a reticle-stage feedback filter (RS FB), a reticle-stage “multi-shot” ILC(RS MILC), a wafer-stage feedback filter (WS FB), and a wafer-stage “multi-shot” ILC (WS MILC). The control system also includes a synchronization target filter.

Based on wafer-stage error sources at frequencies of interest, the target filter controllably allows the reticle stage effectively to track the wafer stage, or at least to ignore certain frequency-specific errors in wafer position. It is advantageous to ignore wafer error due to, for example, sensor measurement noise having a frequency higher than the zero-decibel crossover frequency of reticle-stage sensitivity.

Amplifier slew rate is a potential limitation for an aggressive target notch filter. The target filter desirably is not more aggressive than necessary, at least without relaxing the amplifier slew rate.

Whenever the reticle stage has a higher closed-loop bandwidth than the wafer stage, the reticle stage tracks the wafer stage to reduce synchronization error between wafer and reticle, as illustrated in FIG. 1A. Synchronization errors can be compensated through any of three different approaches: (a) use of a reticle-stage feedback-control filter, (b) use of a reticle-stage ILC, and/or (c) use of a target filter (pre-filter). The reticle-stage feedback-control filter (RS FB filter) can provide base-line synchronization control. To reduce synchronization errors at specific frequencies (that are generally lower than the reticle-stage bandwidth), a peak filter (called, for example, an AFC, “adaptive feed-forward canceller,” although it may be expressed as a fixed-parameter transfer function) may be included in the reticle-stage feedback filter. This approach may disadvantageously have a higher reticle-stage sensitivity peak around the bandwidth frequency. Since this type of filter is located in the reticle-stage closed-loop, it would not be too aggressive due to constraints of stability and performance at other frequencies. Repeatable synchronization errors can be compensated for by the reticle stage ILC (RS MILC).

The synchronization target filter is a powerful synchronization controller. It desirably is located outside the reticle-stage closed-loop (see FIG. 1A), in which event it is generally not constrained by the stability (or lack thereof) of the reticle-stage closed-loop. One might think that the inverse of the reticle-stage closed-loop transfer function would be a perfect target filter; but, this is not actually so because of issues such as time-delay and non-minimum phases. Nevertheless, it is usable effectively to reduce synchronization errors at specific frequencies, discussed below.

The system of FIG. 1A controls motion of a second movable body (e.g., reticle stage) along a second trajectory in coordination with motion of a first movable body (e.g., wafer stage) along a first trajectory. The first controller (WS FB) is programmed or otherwise configured (e.g., by hardware, firmware, software, or combination of these) to produce first driving commands and is connected to deliver the first driving commands to the wafer stage WS. The second controller (RS FB) is programmed or otherwise configured (e.g., by hardware, firmware, software, or combination of these) to produce second driving commands and is connected to deliver the second driving commands to the reticle stage (RS). The first control loop is associated with the first controller (WS FB), and includes feedback to the first controller of position-error data regarding the wafer stage (WS). The second control loop is associated with the second controller (RS FB), and includes feedback to the second controller of position-error data regarding the reticle stage. The synchronization target filter in this embodiment connects the second control loop to outside the first control loop. The target filter is configured to cause the first controller to move the wafer stage in a manner that tracks position-error data of the reticle stage at one or more frequencies of interest.

“Frequencies of interest” are frequencies at which the wafer-stage error cannot be sufficiently compensated by reticle-stage feedback control and/or by reticle-stage ILC. The synchronization target filter enables the reticle stage to track the wafer stage at those frequencies. Usually, before incorporating the target filter into a control system such at that shown in FIG. 1A, only a few frequencies of wafer error remain in the synchronization error (due to wafer-stage and reticle-stage feedback controllers and ILCs). It is not difficult to select the “frequencies of interest” according to the residual synchronization errors. For example, one may select 1-5 frequencies of interest to which to apply the target filter. However, with more target-filter compensation frequencies, the high-frequency area (>1 kHz) of synchronization error tends to degrade, which imposes a realistic limit on the number of frequencies.

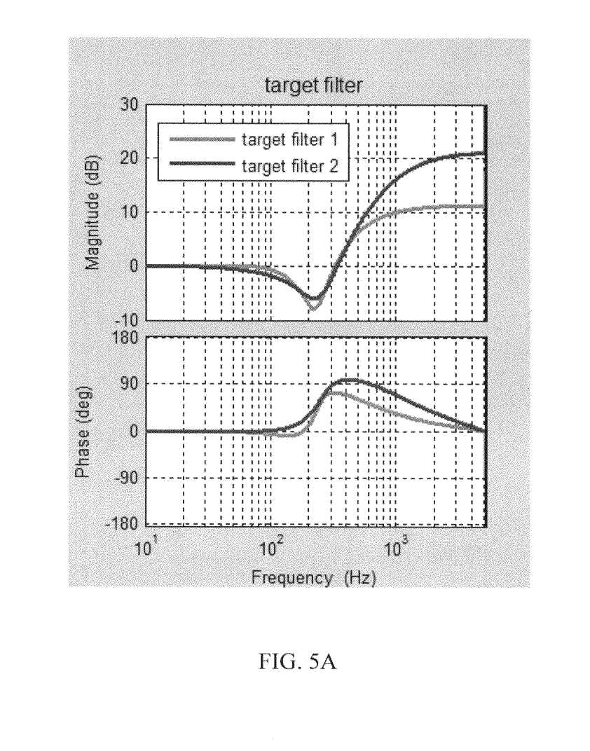

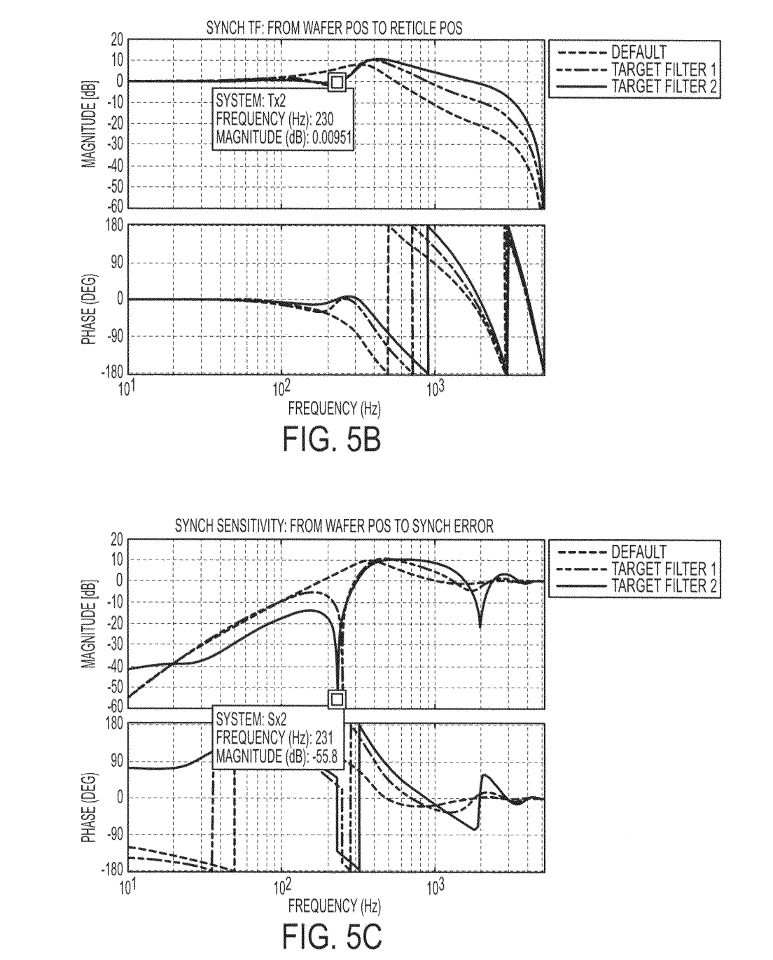

For control of synchronization of both the wafer stage and reticle stage in this embodiment, the reticle stage tracks the wafer stage, as controlled by the synchronization target filter. The filter is called a “target” filter because it is applied to the positioning information for the wafer stage (as a first movable body) that is used as a target for the reticle stage (as a second movable body) to track. The target filter is termed an “aggressive” filter because it can create a wider notch in the synchronization sensitivity frequency response (see discussion below regarding FIGS. 5A-5C). Whereas this response will reduce the synchronization error more at the associated notch frequency (“frequency of interest”), it will also degrade the high-frequency synchronization more.

The system of FIG. 1A also includes a first iterative learning controller (RS MILC) associated with the first control loop (wafer-stage control loop) and a second iterative learning controller (WS MILC) associated with the second control loop (reticle-stage control loop). (The letter “M” denotes that, in this embodiment, the ILC iteratively learns from a trajectory in an actual exposure sequence covering an entire wafer (multi-shot).) The first (wafer-stage) control loop is closed, and the synchronization target filter is connected between the reticle-stage MILC outside the first control loop. The wafer-stage MILC provides input to the first controller (WS FB filter). The second control loop (RS) is closed, and the reticle-stage MILC is connected to it. Thus, the “RS closed loop” (RS CL) includes the RS FB filter (C(s)) and the reticle stage (P(s)). The transfer function of the RS CL (from its position reference to its position output) is

$${T}_{RS} ( s ) = \frac{P ( s ) \cdot C ( s )}{1 + P ( s ) \cdot C ( s )} .$$

Thus, FIG. 1A schematically depicts an embodiment of the subject control system applied to establishing synchronous motion of a wafer stage with a reticle stage (or with respective objects held and moved by these stages). The wafer-stage controller and reticle-stage controller (called WS FB filter and RS FG filter, respectively) provide command outputs to the reticle stage and wafer stage, respectively. First and second control loops provide feedback-control data to the first and second controllers regarding positions of the first and second movable bodies, respectively. The WS ILC (MILC in this embodiment) and RS ILC (MILC in this embodiment) are connected to the first and second control loops, respectively. The RS MILC allows the reticle stage to compensate for repeatable positioning errors in the wafer stage.

The synchronization target filter is connected outside the first closed loop and is programmed (or otherwise configured) to track motions of the wafer stage WS and reticle stage RS and to cause the WS FB controller to move the wafer stage WS synchronously with motion of the reticle stage RS at one or more frequencies of interest. The target filter desirably comprises at least one notch filter, corresponding to a respective notch frequency of interest, and at least one phase-lead filter. The target filter is programmed to produce optimized parameters and to control stage motions, using a cost function of synchronization-error MA and MSD.

The synchronization target filter is used to, inter alia, compensate for errors in the first movable body (wafer stage) at specified frequencies, which may not be repeatable. The synchronization target filter can be utilized with or without the RS ILC. When used with the RS ILC, synchronization control as achieved by the target filter may be improved over use without the RS ILC.

### Target Filter Based on a Single Sensitivity Notch

The target filter for the reticle-stage closed-loop system tracks wafer error effectively at one or more frequencies of interest without excessively degrading control at other frequencies. In order for the target filter H(s) to assist the reticle closed-loop control system T_{RS}(s) so as to track the wafer-stage error at a frequency w, either a synchronization sensitivity of zero (Equation (1)) or a unit-synchronization transfer function (Equation (2)) is required.

S_{synch}(jw)=1−H(jw)·T_{RS}(jw)=0 (1)

H(jw)·T_{RS}(jw)=1 (2)

in which j is \sqrt{−1}, w is frequency in radians, s is a Laplace Transform variable, and s=jw in the frequency domain. A simple target filter H(s) may include a second-order notch filter (G_{notch}(s)), for tracking at the frequency of interest, and a phase-lead filter (G_{lead}(s)) to maintain performance in other frequency areas).

H(s)=G_{lead}(s)·G_{notch}(S) (3)

See FIG. 1B, depicting a synchronization target filter H(s) including n notch filters. The notch filter desirably has the following property for achieving substantially perfect tracking at the frequency of interest w:

$${G}_{notch} ( j w ) = \frac{1}{{T}_{RS} ( j w ) \cdot {G}_{lead} ( j w )} \qquad ( 4 )$$

Since the requirement of Equation (4) should be met in both real and imaginary parts, two degrees of design freedom are left for a second-order notch filter (Equation (5)) with four parameters w₁, w₂, d₁, and d₂:

$${G}_{notch} ( s ) {\vert}_{s = jw} = \frac{\frac{{s}^{2}}{{w}_{1}^{2}} + 2 {d}_{1} \frac{s}{{w}_{1}} + 1}{\frac{{s}^{2}}{{w}_{2}^{2}} + 2 {d}_{2} \frac{s}{{w}_{2}} + 1} {\vert}_{s = jw} = h = a + j \cdot b \qquad ( 5 )$$

With two more conditions (e.g., assigning the denominator-damping ratio d₂, and the frequency ratio

$$r = \frac{{w}_{2}}{{w}_{1}} ) ,$$

after some manipulations the other three filter parameters w₁, w₂, and d₁ may be obtained as follows.

$$\begin{matrix}{w}_{1} = \frac{- {c}_{2} + \sqrt{{c}_{2}^{2} - 4 {c}_{1} {c}_{3}}}{2 {c}_{1}} & ( 6 A ) \\ {w}_{2} = r \cdot {w}_{1} & ( 6 B ) \\ {d}_{1} = b \cdot \frac{{r}^{2} {w}_{1}^{2} - {w}^{2}}{2 \cdot {r}^{2} {w}_{1} w} + a \cdot \frac{{d}_{2}}{r} & ( 6 C )\end{matrix}$$

where:

c₁=(1−a)·r² (7A)

c₂=2d₂rbw (7B)

c₃=−(r²−a)—w² (7C)

The following Matlab function allowed assignment of parameters of the second-order filter with the following input arguments:
complex-number filter response: h=a+j·b
frequency of interest: w
denominator-damping ratio: d₂
frequency ratio:

$$r = \frac{{w}_{2}}{{w}_{1}}$$

function [w1Hz, w2 Hz, d1, d2]=filtTarget2(wHz, h, d2, r)
% [w1Hz, w2 Hz, d1, d2]=filtTarget2(wHz, h, d2, r)
% To assign a 2nd order filter with a complex number h at frequency wHz,
% denominator damping ratio d2 and frequency ratio r=w2 Hz/w1Hz
w=wHz*2*pi;
a=real (h);
b=imag(h);

c1=r̂2*(1−a);

c2=2*d2*r*b*w;

c3=−(r̂2−a)*ŵ2;

w1=(−c2+sqrt(c2̂2−4*c1*c3))/(2*c1);

The continuous-time parameters of the target notch filter can be calculated using Equations (4) and (5), using the responses of a discrete time-lead filter and a measured reticle-stage transfer function at the assigned sensitivity notch frequency w. Then, for the best discrete time implementation, a continuous-to-discrete conversion of the target notch filter is pre-warped at the assigned sensitivity notch frequency w.

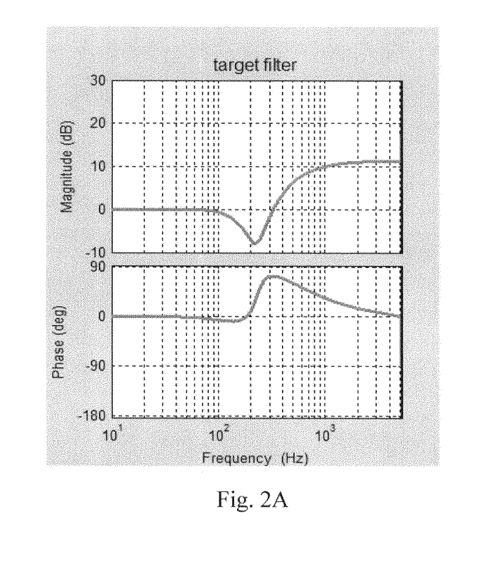

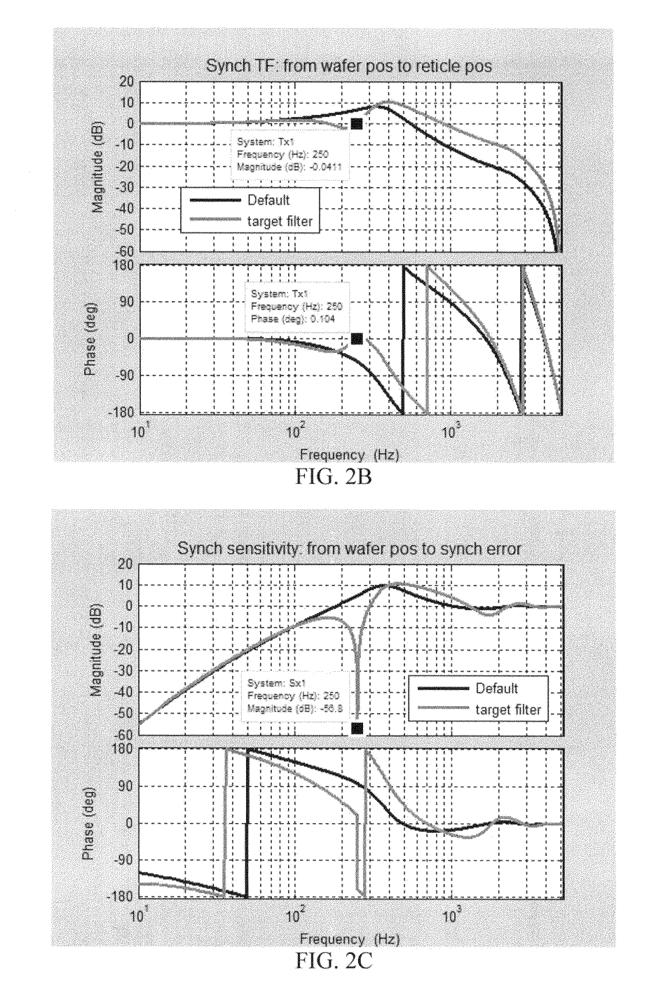

Shown in FIGS. 2A, 2B, and 2C are simulated frequency responses of the synchronization transfer function and sensitivity, both without (“default”) and with the target filter. The target filter of this embodiment creates a 250-Hz sensitivity notch having a damping ratio d₂=1 and a frequency ratio r=1. The associated lead filter (35° and 200 Hz) is finely adjusted to maintain the same magnitude of lower-frequency sensitivity as in the default. With these design parameters, the remaining parameters of the target notch filter parameters (wᵣ, W₂, d_{I}) can be computed based on Equations (6A)-(6C) and (7A)-(7C).

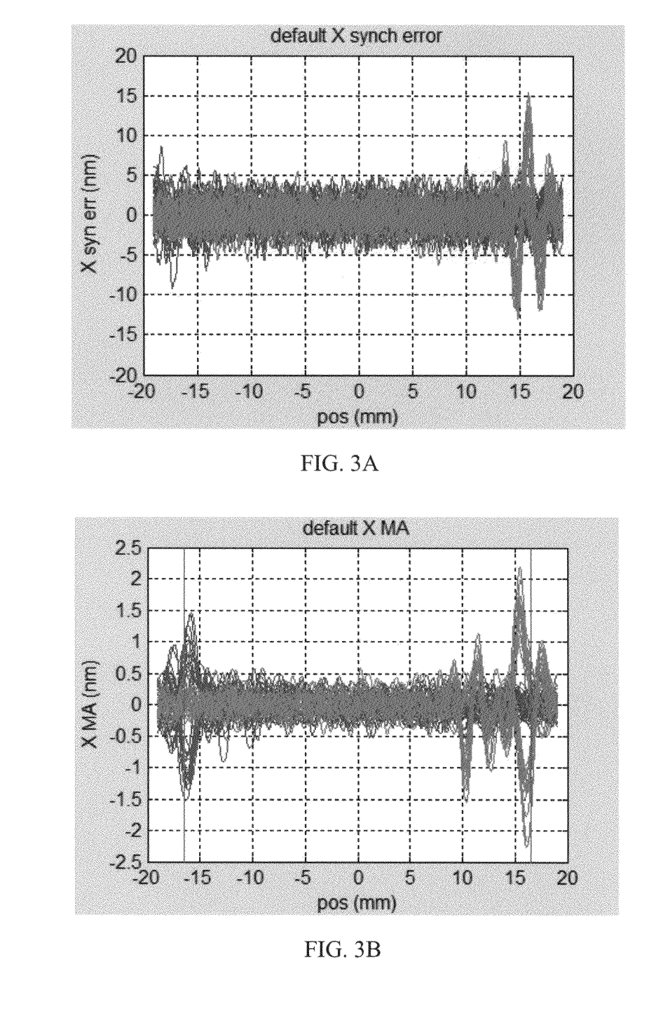

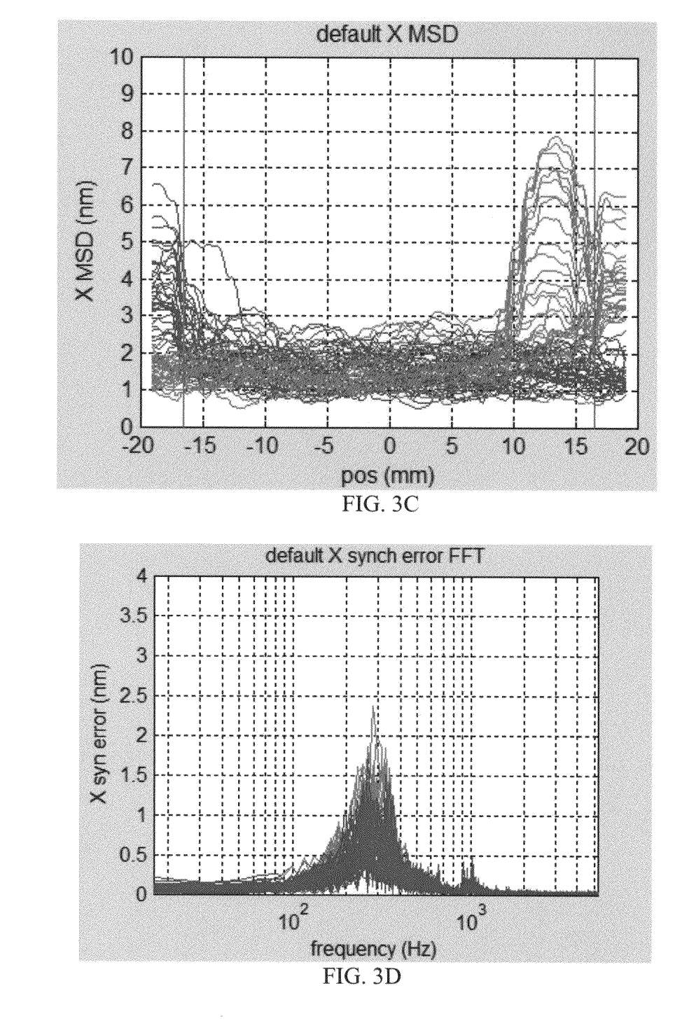

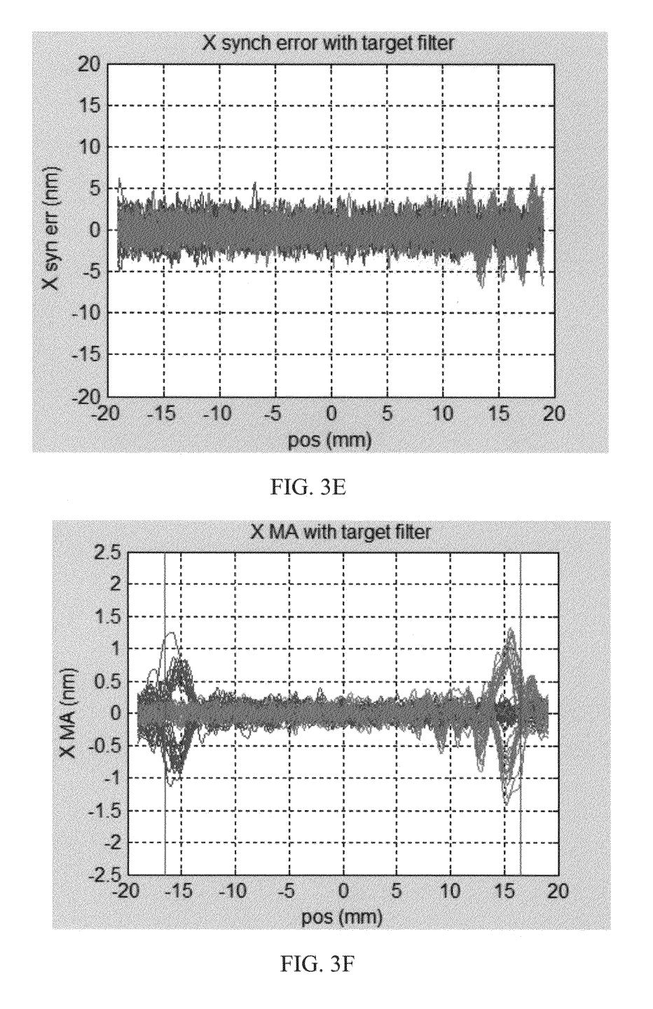

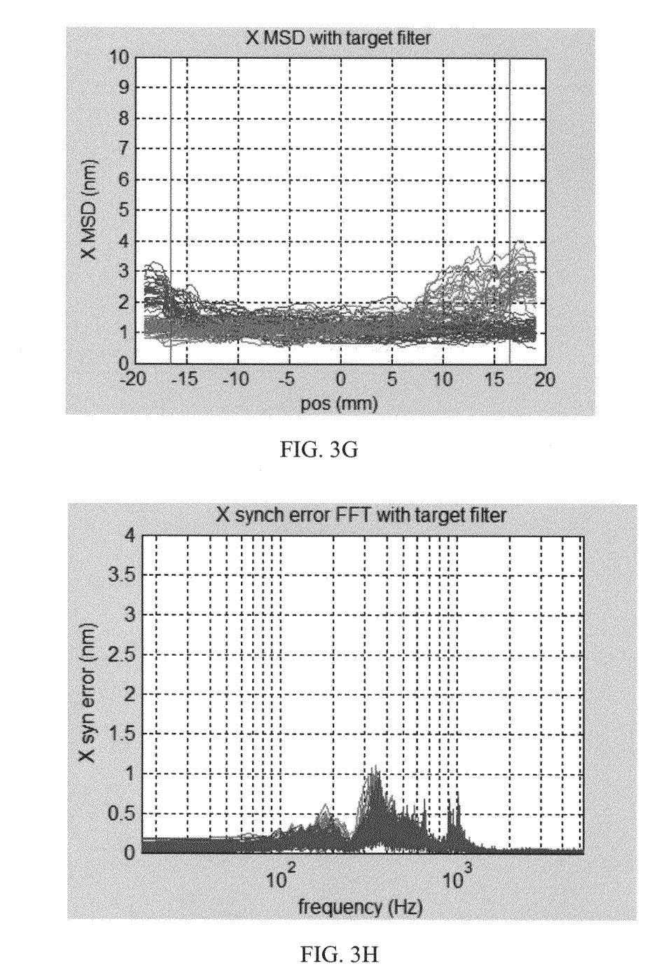

From the simulated comparisons of synchronization accuracy without the target filter (FIGS. 3A-3D) and with the target filter (FIGS. 3E-3H), it can be seen that the target filter significantly suppresses synchronization error at 250 Hz.

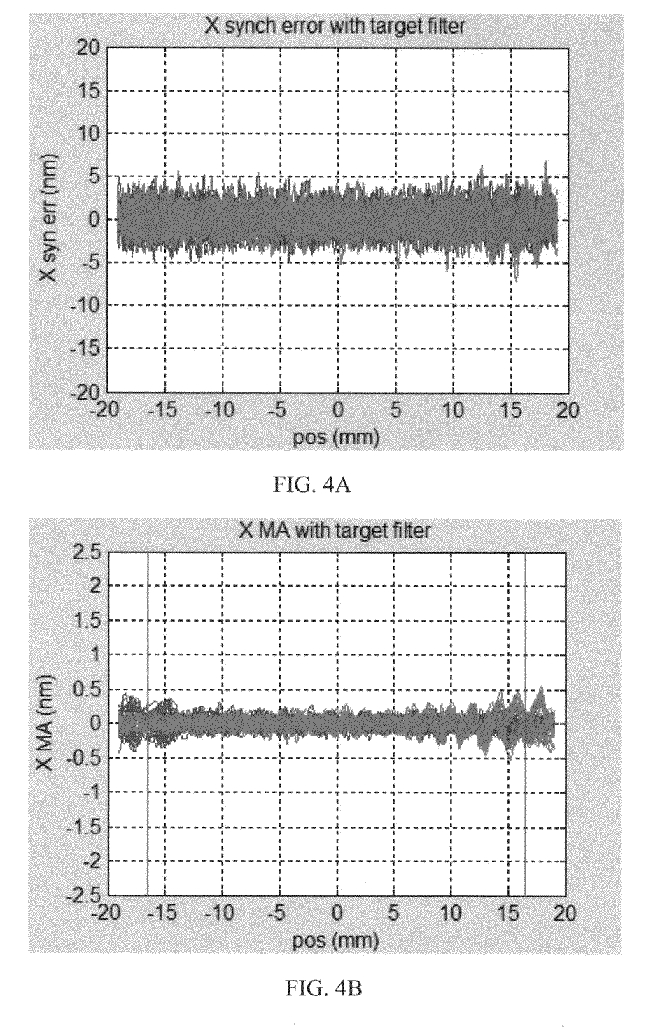

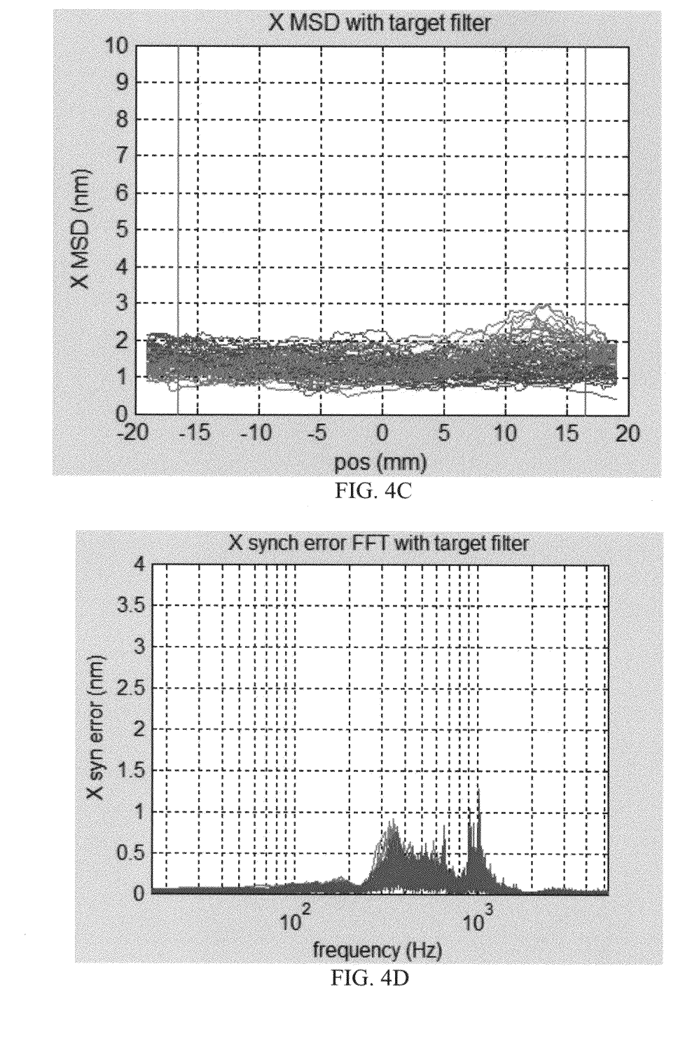

If the target filter (filter 1) is not quite meeting specification, the frequency of the sensitivity notch can be shifted slightly, along with increasing the damping ratio d₂ and adjusting the associated lead filter (filter 2). In an example configured according to this embodiment, a particular set of target-filter parameters (notch of 230 Hz, damping ratio d₂=2, and a 240-Hz and 57° phase lead filter) of the lead filter further reduced the synchronization error MA and MSD (moving average and moving standard deviation, respectively). Since MA depends more on a lower-frequency synchronization error, achieving a better MA can result from allocating the sensitivity notch at a frequency that is slightly lower than the peak FFT frequency. See FIGS. 4A-4D.

FIGS. 5A-5C depict a comparison of the synchronization-sensitivity frequency responses of target filters 1 and 2. Compared to target filter 1, target filter 2 created a wider notch that covered a more lower-frequency region. Meanwhile, the target filter 2 produced a greater amplification of the higher-frequency sensitivity, which was reflected in the higher synchronization-error peaks at 900 and 1000 Hz in the FFT plots.

Hence, additional target notch filters can be used to reduce high-frequency synchronization errors (which are amplified by the lower-frequency wide-target notch filters). On the other hand, to compensate for large-frequency-range synchronization errors without obvious peaks, utilization of several narrower notches at slightly different frequencies is an alternative to using a single wide notch.

### Target Filter Having Multiple Sensitivity Notches

This embodiment is directed to a target filter that performs multiple-frequency tracking. When the target filter is applied to a reticle stage to achieve synchronization control at several frequencies of interest (w=wₙ₁, wₙ₂, . . . ), the following conditions of synchronization sensitivity (Equation (8)) and of the equivalent synchronization transfer function (Equation (9)) should be met:

S_{synch}(jw)=1−H_{target}(jw)·T_{RS}(jw)=0 at w=wₙ₁,wₙ₂, . . . (8)

T_{synch}(jw)=H_{target}(jw)·T_{RS}(jw)=1 at w=wₙ₁,wₙ₂, . . . (9)

in which T_{RS} and H_{target} are the reticle-stage closed-loop transfer function and the associated synchronization-control target filter, respectively. The target filter may comprise a lead filter and several notch filters (second-order shaping filters) associated with the frequencies of interest. For simplicity without losing sight of generality, we consider only two notches, as expressed in Equation (10):

H_{target}(s)=G_{lead}(s)·G_{notch,1}(s)·G_{notch,2}(s) (10)

Substitution of Equation (10) into the perfect-tracking condition expressed in Equation (9) leads to the following two requirements, which desirably are met simultaneously:

$$\begin{matrix}{G}_{notch , 1} ( j {w}_{n 1} ) = \frac{1}{{T}_{RS} ( j {w}_{n 1} ) \cdot {G}_{lead} ( j {w}_{n 1} ) \cdot {G}_{notch , 2} ( j {w}_{n 1} )} & ( 11 A ) \\ {G}_{notch , 2} ( j {w}_{n 2} ) = \frac{1}{{T}_{RS} ( j {w}_{n 2} ) \cdot {G}_{lead} ( j {w}_{n 2} ) \cdot {G}_{notch , 1} ( j {w}_{n 2} )} & ( 11 B )\end{matrix}$$

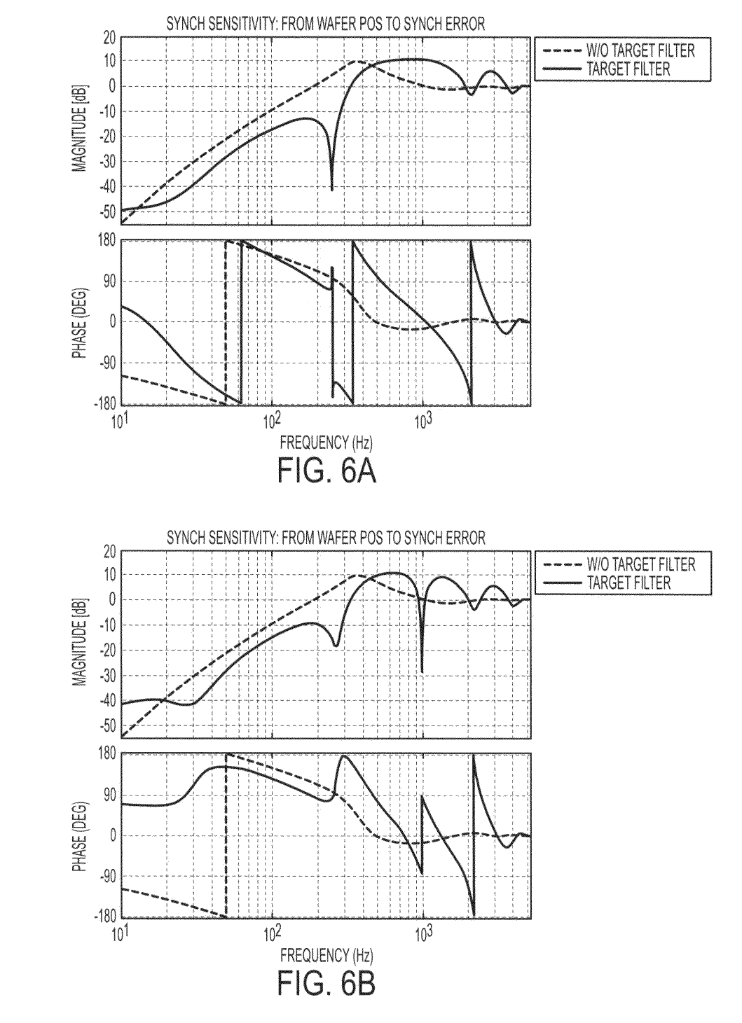

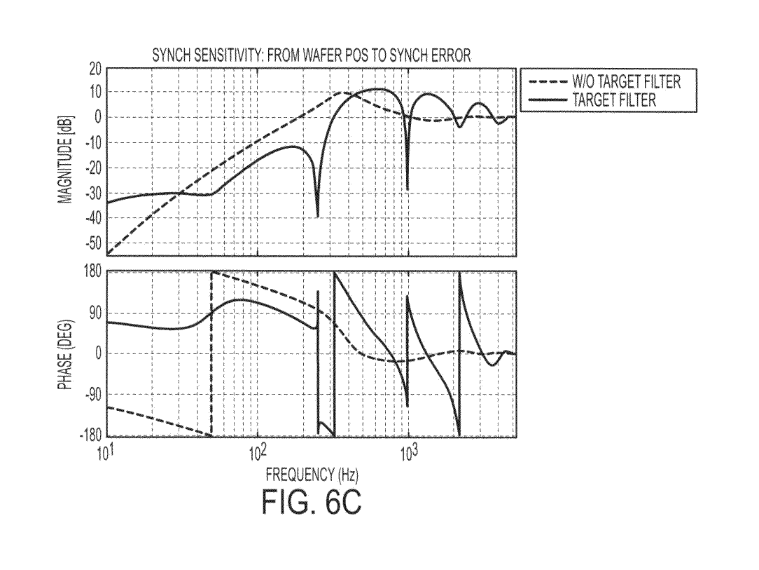

To meet each of these requirements individually, a simple form of analytical solution may be used for the filter parameters of a second-order notch filter as described by the Matlab function [w1Hz, w2 Hz, d1, d2]=filtTarget2(wHz, h, d2, r) discussed above. To meet these two requirements simultaneously, two second-order equations are solved to obtain the filter parameters. For simplicity, an iterative protocol may alternatively be used to approximate the ideal notch-filter parameters. For instance, the first notch filter can be configured with condition (12A) alone (with the help of the Matlab function filtTarget2). See FIG. 6A. Then, the second notch filter may be configured with condition (12B), which already takes into consideration the newly configured first notch filter. If we stop here, the second notch appears very sharp in the synchronization-sensitivity frequency-response Bode diagram, but the first notch becomes less sharp as desired (FIG. 6B). If the configuration of the first notch-filter is repeated (Equation (12C)), which also takes the new second notch filter into account, then the configuration of the first notch filter is also close to perfect (FIG. 6C). More design iterations lead to more precise results.

$$\begin{matrix}{G}_{notch , 1} ( j {w}_{n 1} ) = \frac{1}{{T}_{RS} ( j {w}_{n 1} ) \cdot {G}_{lead} ( j {w}_{n 1} )} & ( 12 A ) \\ {G}_{notch , 2} ( j {w}_{n 2} ) = \frac{1}{{T}_{RS} ( j {w}_{n 2} ) \cdot {G}_{lead} ( j {w}_{n 2} ) \cdot {G}_{notch , 1} ( j {w}_{n 2} )} & ( 12 B ) \\ {G}_{notch , 1} ( j {w}_{n 1} ) = \frac{1}{{T}_{RS} ( j {w}_{n 1} ) \cdot {G}_{lead} ( j {w}_{n 1} ) \cdot {G}_{notch , 2} ( j {w}_{n 1} )} & ( 12 C )\end{matrix}$$

Using the same principles as described above, the respective parameters for three, four, or more frequencies can be iteratively solved.

### Target Filter Optimization

In this section, the target filter is optimized using the Simplex method. Optimization is performed for synchronization performance index values such as MA (moving average) and MSD (moving standard deviation).

The Simplex method is applied to target-filter optimization with a cost function (Equation (13)) of the weighted synchronization error MA and MSD. This cost function considers all the Nₑₓₚ exposure-data samples in every scan of all Nₛₕₒₜ on a wafer:

$$J = \sqrt{\frac{1}{( 1 + {β}^{2} ) \cdot {N}_{shot} \cdot {N}_{exp}} {\sum }_{i = 1}^{Nshot} {\sum }_{k = 1}^{{N}_{exp}} {MA}^{2} ( k , i ) + {β}^{2} \cdot {MSD}^{2} ( k , i )} \qquad ( 13 )$$

The MSD weighting parameter β in the cost function was used to fine-tune the MA and MSD relative performances.

For optimization of the X target filter with MSD weighting β=0.05, the target filter included two notch filters and a lead filter to provide synchronization-sensitivity notches at around 250 Hz and 1 kHz, respectively. Six parameters to be optimized were frequency and phase of the lead filter, and notch frequency and damping ratio of each of the two synchronization-sensitivity notches, i.e., w_{lead}, θ_{lead}, w_{notch,1}, d_{notch,1}, w_{notch,2}, and d_{notch,2}. The initial conditions were: w_{notch1}=180 Hz, θ_{lead}=30°, w_{lead}=250 Hz, d_{notch,1}=1, w_{notch,2}=1000 Hz, and d_{notch,2}=0.1. Respective sets of reasonable lower and upper bounds were also established:

| Initial | Lower | Upper |
|---|---|---|
| w_{lead} = 180 Hz | 10 Hz | 5 × 10³ Hz |
| θ_{lead} = 30° | 10° | 85° |
| w_{notch, 1} = 250 HZ | 10 Hz | 5 × 10³ Hz |
| d_{notch, 1} = 1 | 1 × 10⁻⁶ | 3 |
| w_{notch, 2} = 1000 Hz | 10 Hz | 5 × 10³ Hz |
| d_{notch, 2} = 0.1 | 1 × 10⁻⁶ | 3 |

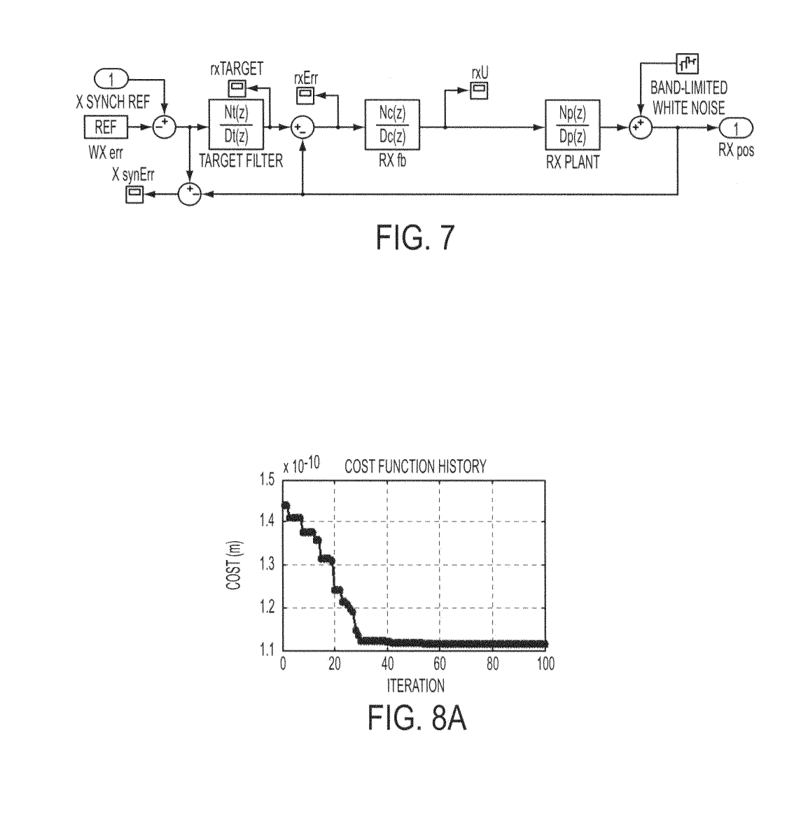

The actual parameters (w₁, W₂, dᵣ, d₂) of each synchronization notch filter desirably are calculated based on the reticle-stage closed-loop transfer function and other target filters as described above. For discrete time implementations with these notch filters, bilinear c2d conversions were performed and pre-warped at the desired synchronization-sensitivity notch frequency w_{notch}, not at the filter's numerator frequency w₁ or denominator frequency w₂. In the various simulations disclosed herein, for simplicity no ILC is used, and a target notch filter is used to compensate for wafer-error variations. The wafer-error difference of wafers #1 and #10 (real machine data obtained at a scan speed of 625 mm/s) was used as the input of the target filter. No amplifier slew rate limitation was applied. See FIG. 7.

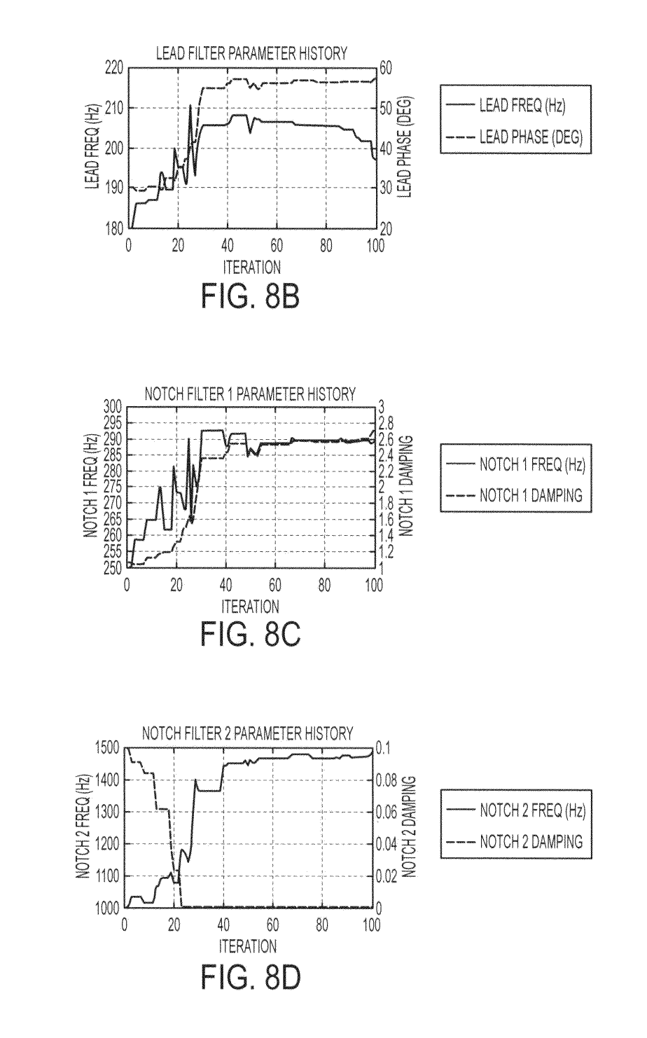

Simplex optimization with MSD weighting β=0.05 converged well according to the history of the cost function and the target-filter parameters (FIGS. 8A-8D). In the second notch-filter damping was reduced to 10⁻⁶ and its frequency increased up to 1.5 kHz. This suggests that it is not needed here for performance optimization in terms of this specific cost function.

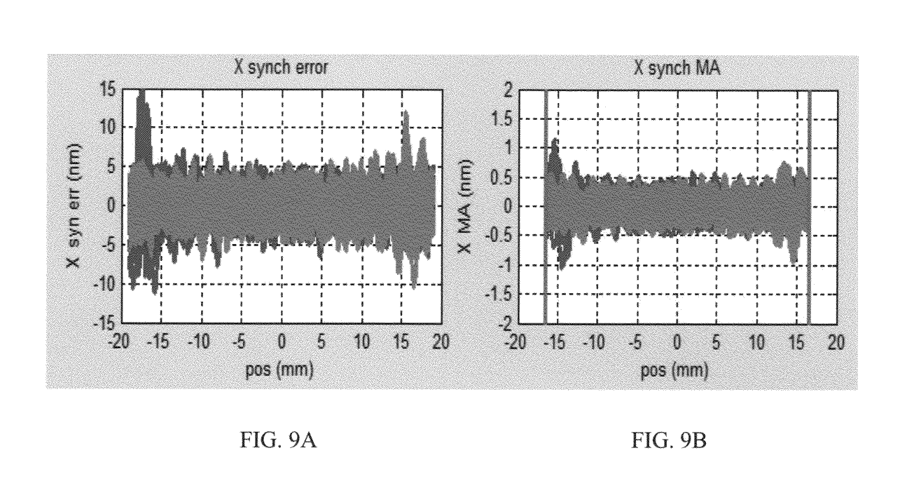

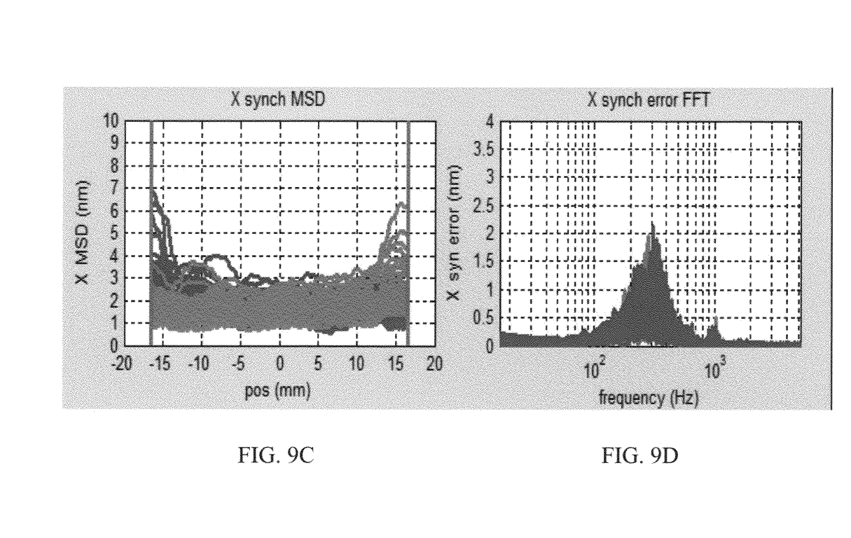

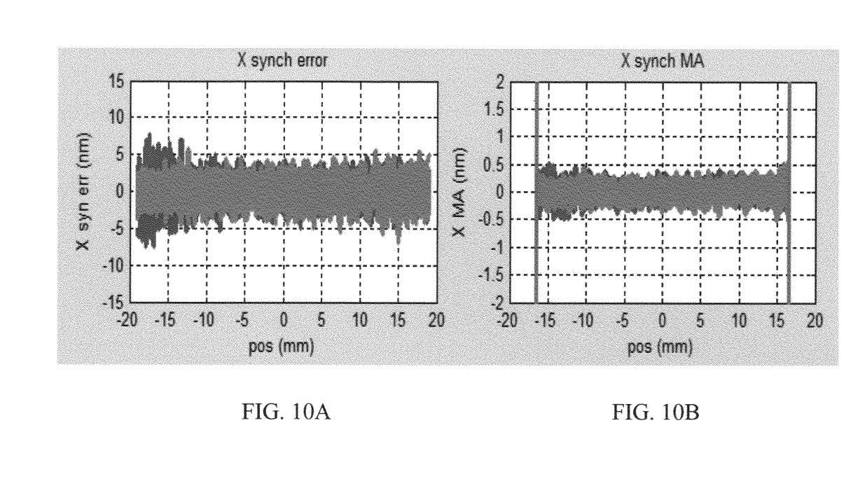

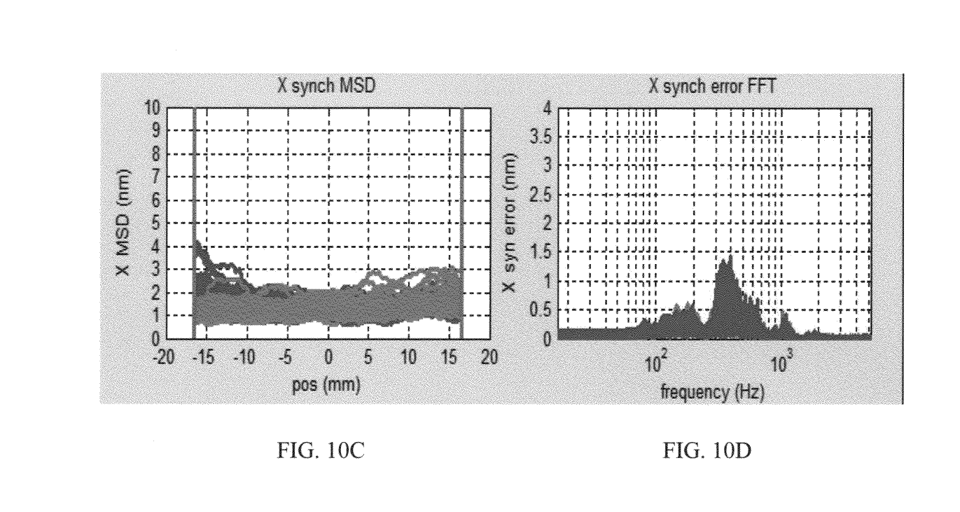

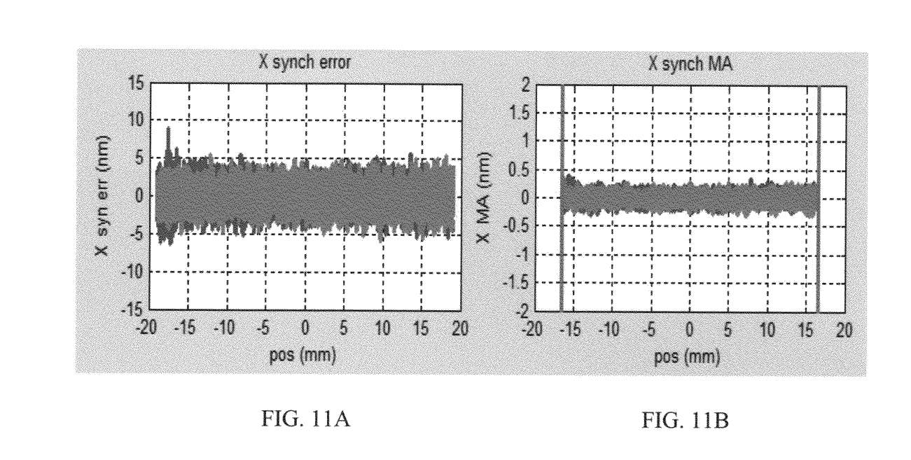

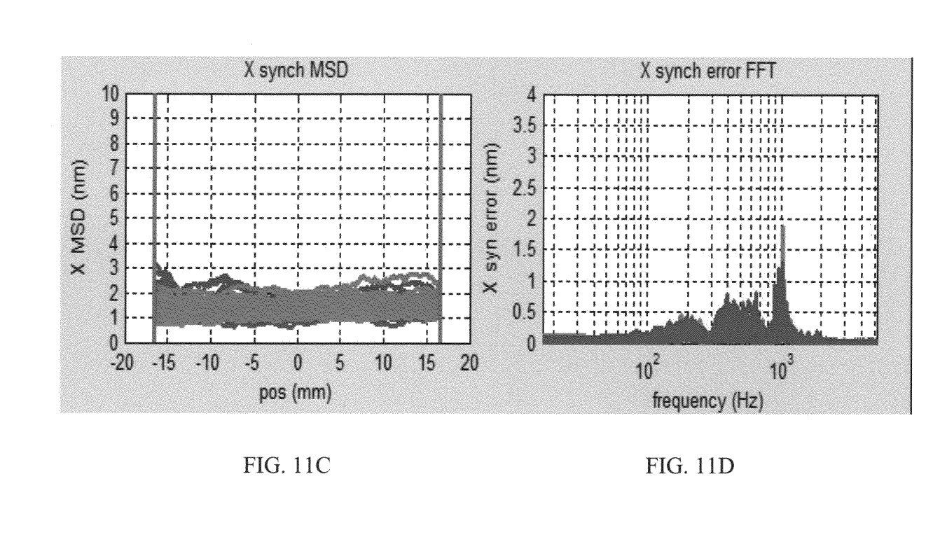

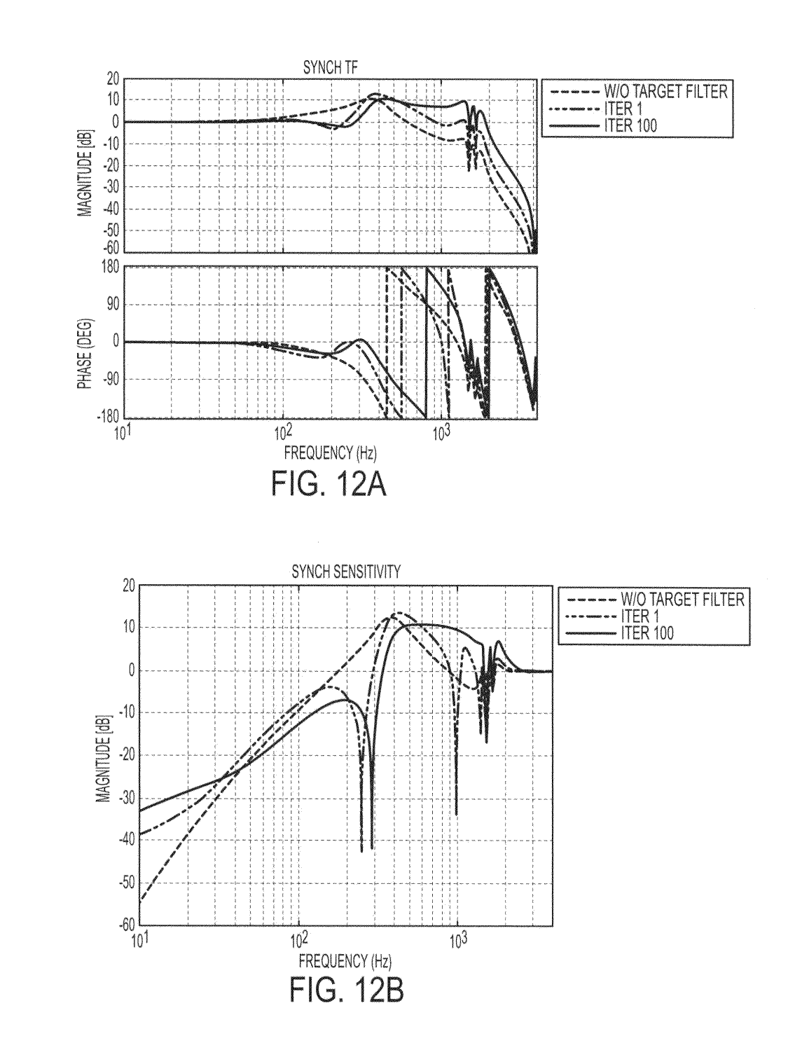

A comparison of FIGS. 9A-9D and FIGS. 10A-10D shows that the initial target filter already worked quite well. The optimization process with MSD weighting β=0.05 further improved both the MA and MSD values noticeably (compare FIGS. 10A-10D with FIGS. 11A-11D). The synchronization-frequency responses in cases lacking a target filter, cases including initial target filters, and cases including optimized target filters are plotted in FIGS. 12A-12C. By optimization, the major synch-sensitivity notch was moved from its initial frequency of 250 Hz toward 300 Hz. Meanwhile, the notch width was expanded for more aggressive compensation. The secondary notch (initially at 1 kHz) became invisible after optimization (1.5 kHz, damping ratio 10⁻⁶).

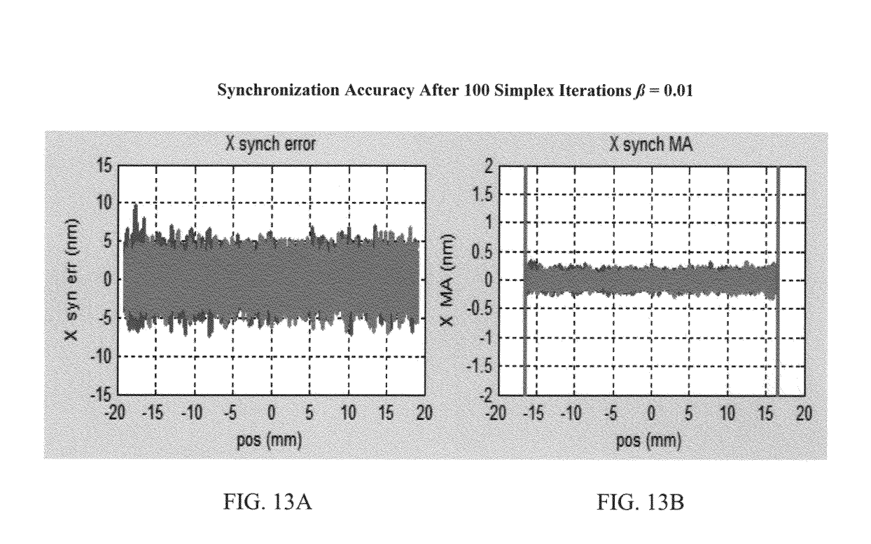

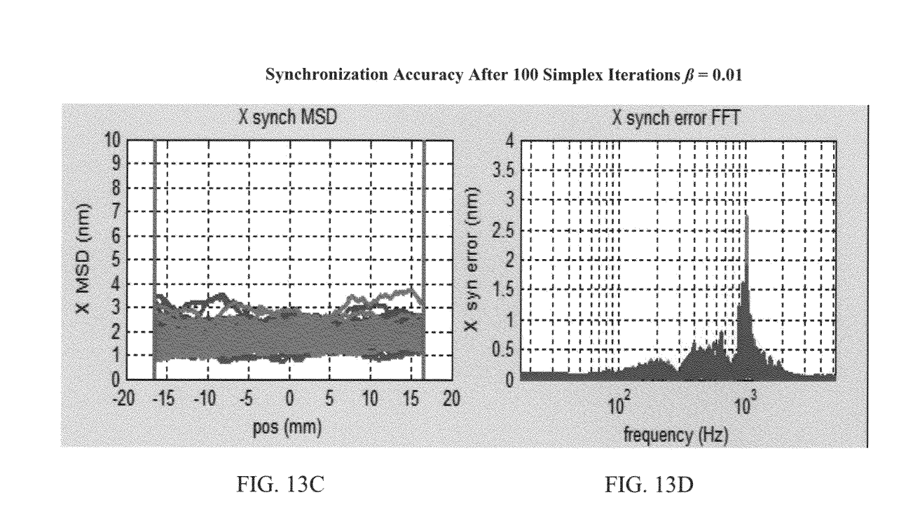

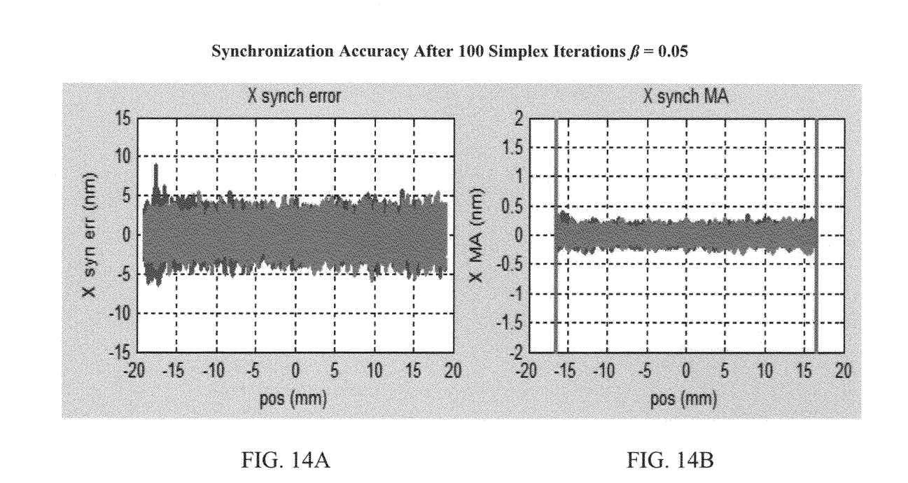

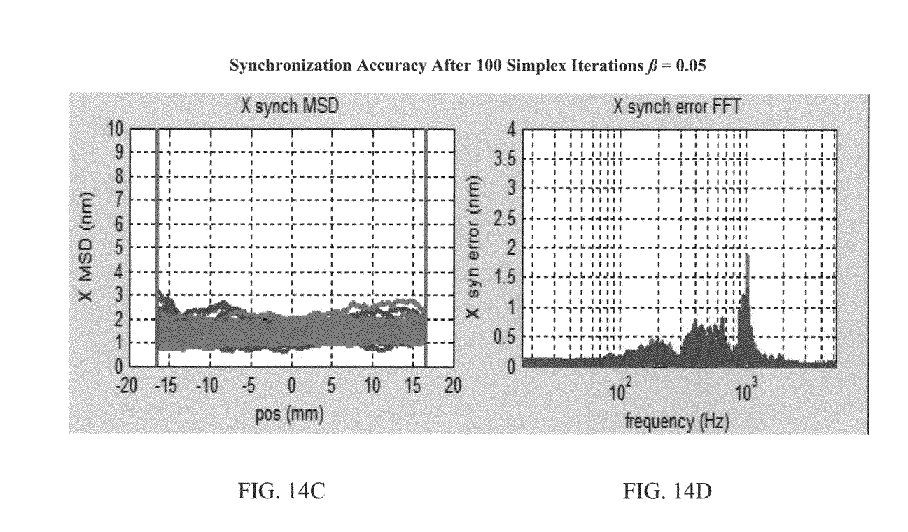

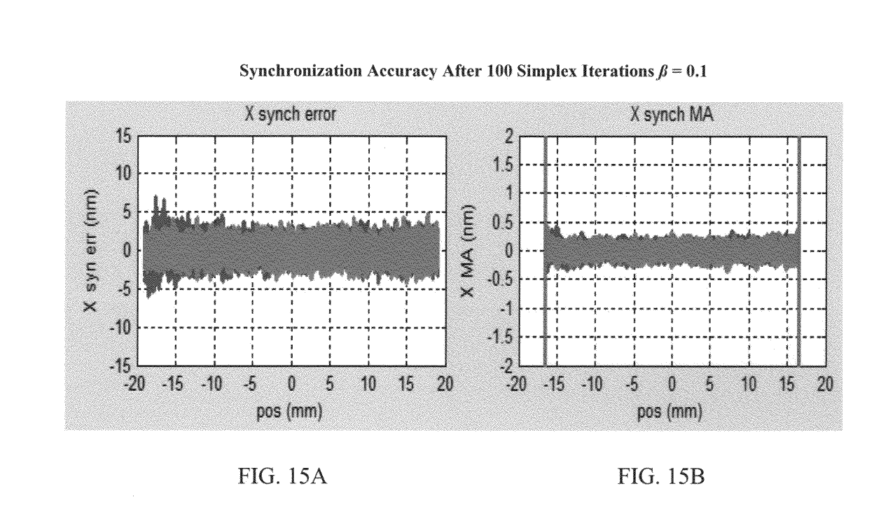

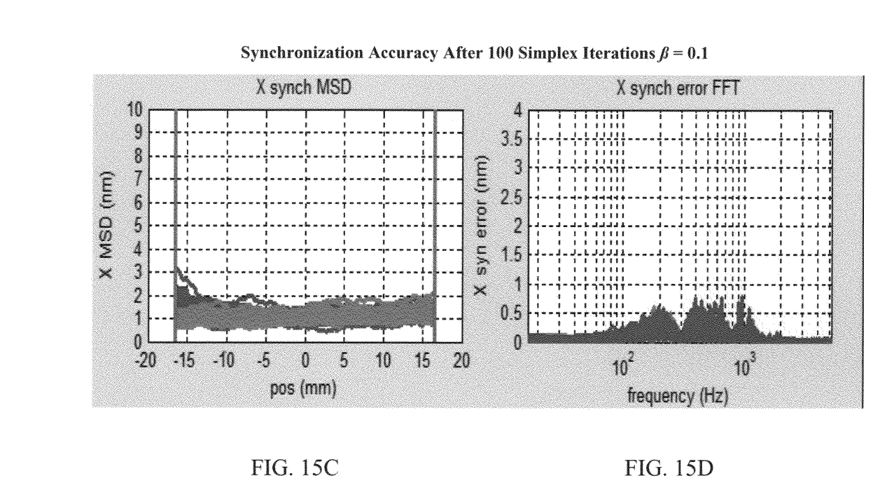

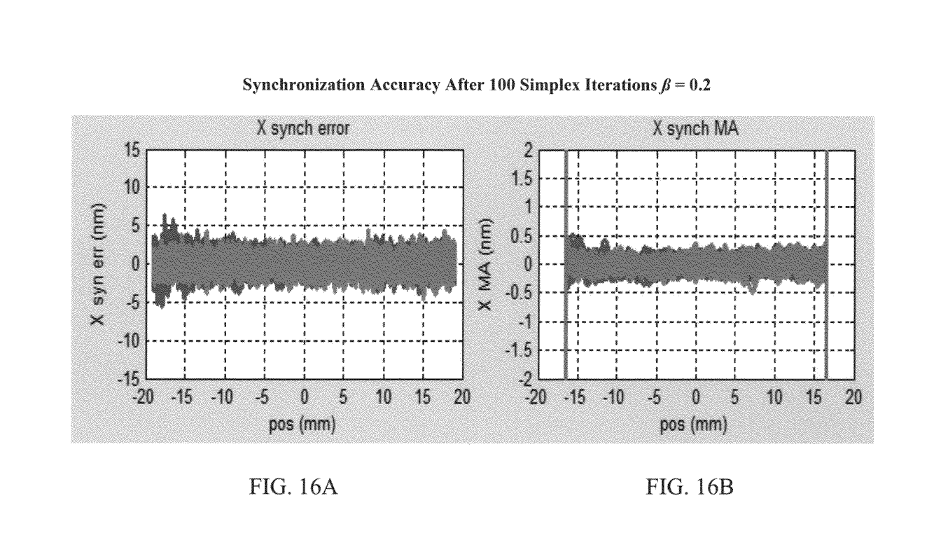

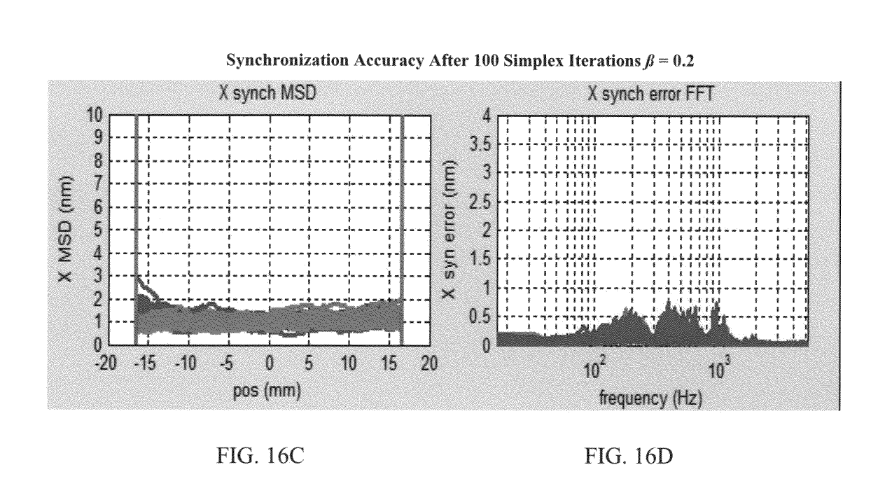

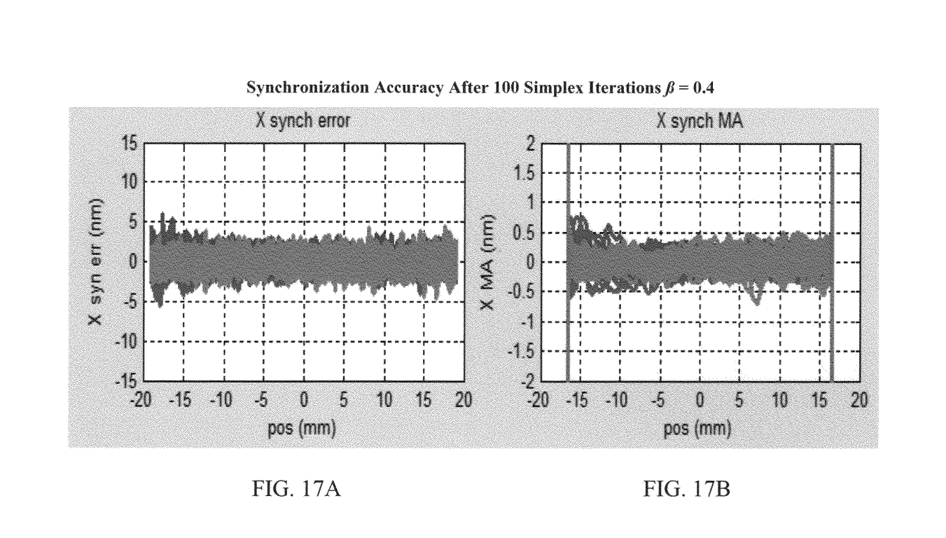

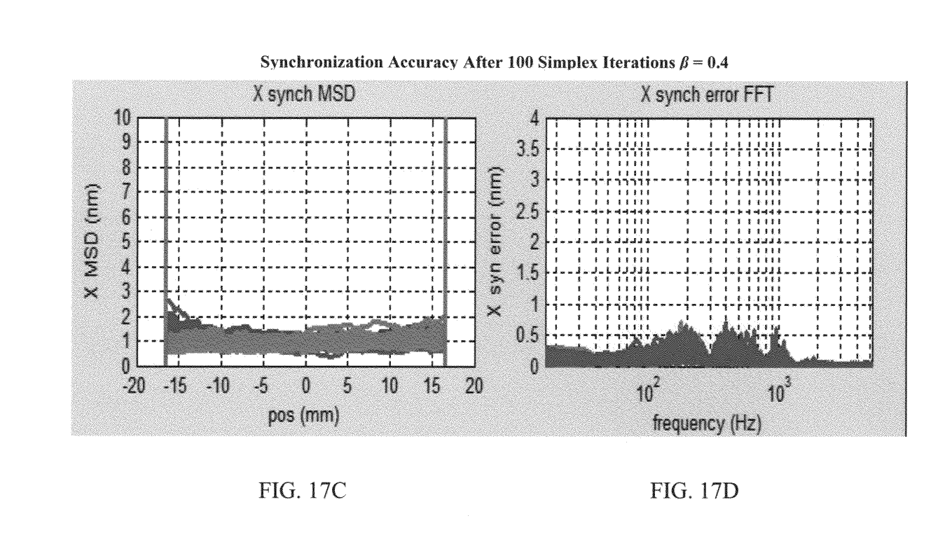

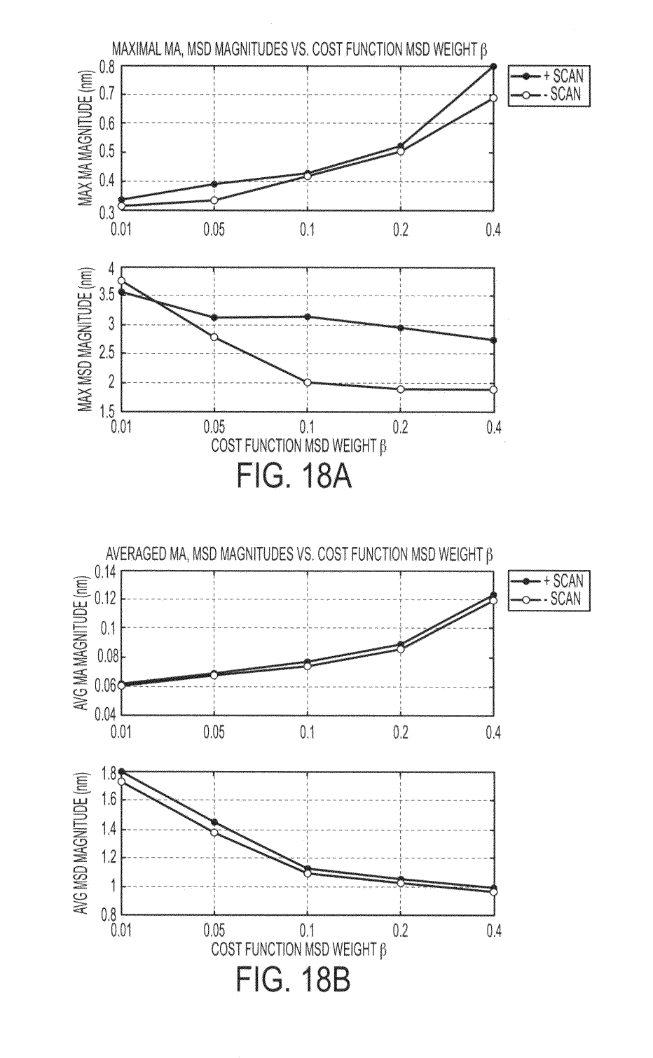

To compare optimizations with different MSD weightings (β), optimizations were repeated with different values of MSD weighting to evaluate their correlations to the final synchronization performance. Larger MSD weighting led to better MSDs but poorer MAs after optimization, as shown in FIGS. 13A-13D, 14A-14D, 15A-15D, 16A-16D, and 17A-17D, which depict respective synchronization accuracies obtained after 100 Simplex optimization iterations. From the FFT plots (FIGS. 13D, 14D, 15D, 16D, and 17D), lower MSD weighting led to a more outstanding 1-kHz error peak and smaller magnitudes in lower frequency areas, and vice versa. To summarize these optimization results, FIGS. 18A-18C provide the maximal and averaged MA and MSD values of the plus and minus scans over the entire wafer vs. MSD weighting after 100 Simplex iterations for the reference. Basically, optimization with larger MSD weighting yielded better MSD but worse MA, and vice versa.

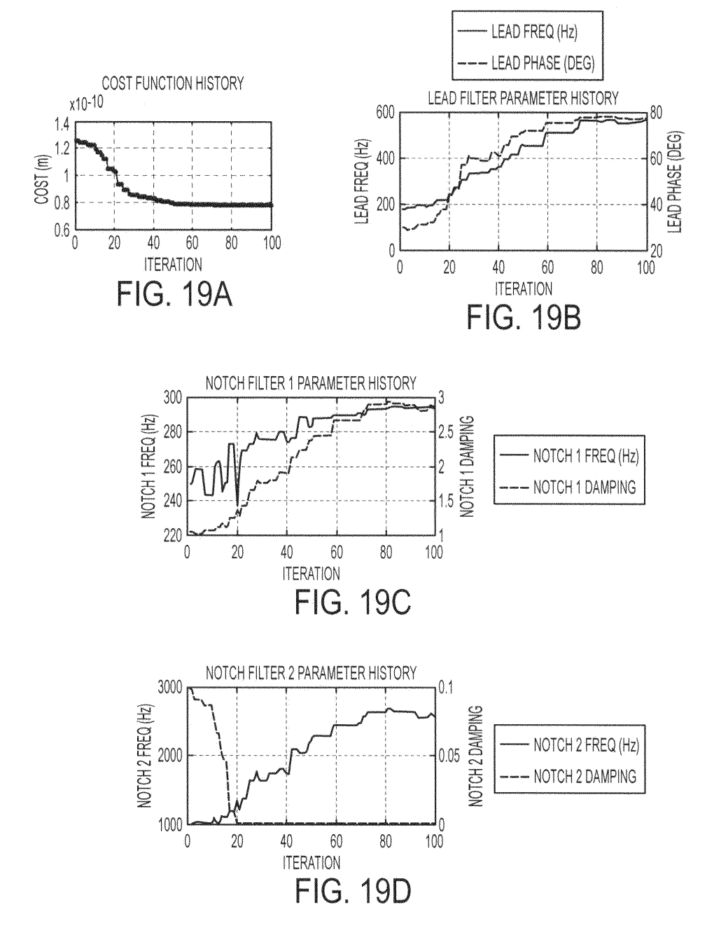

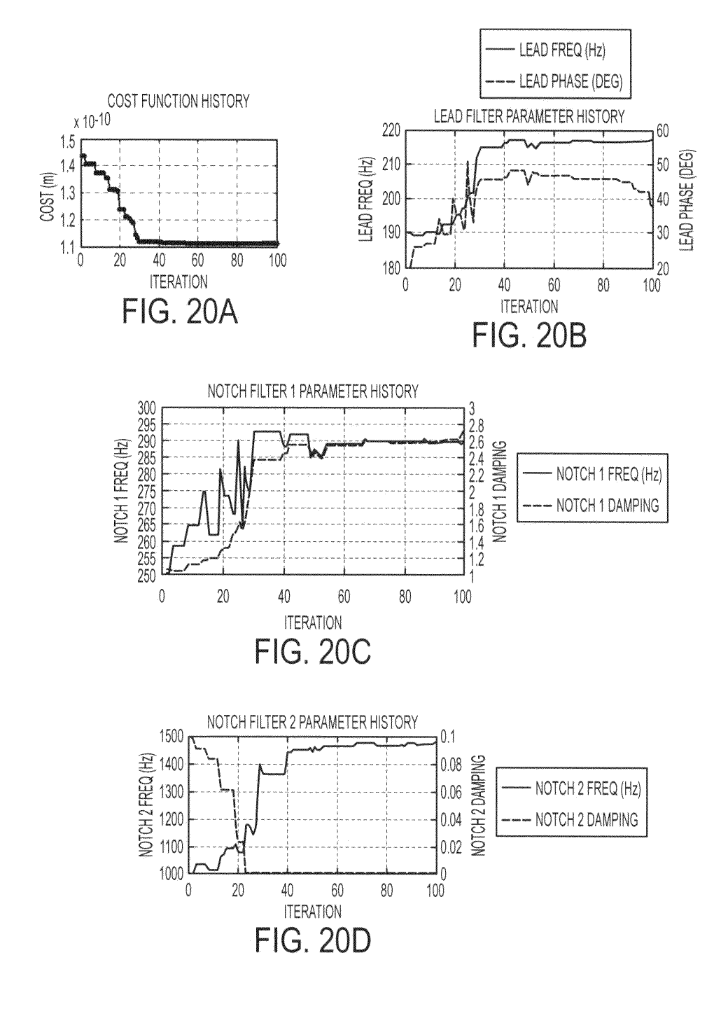

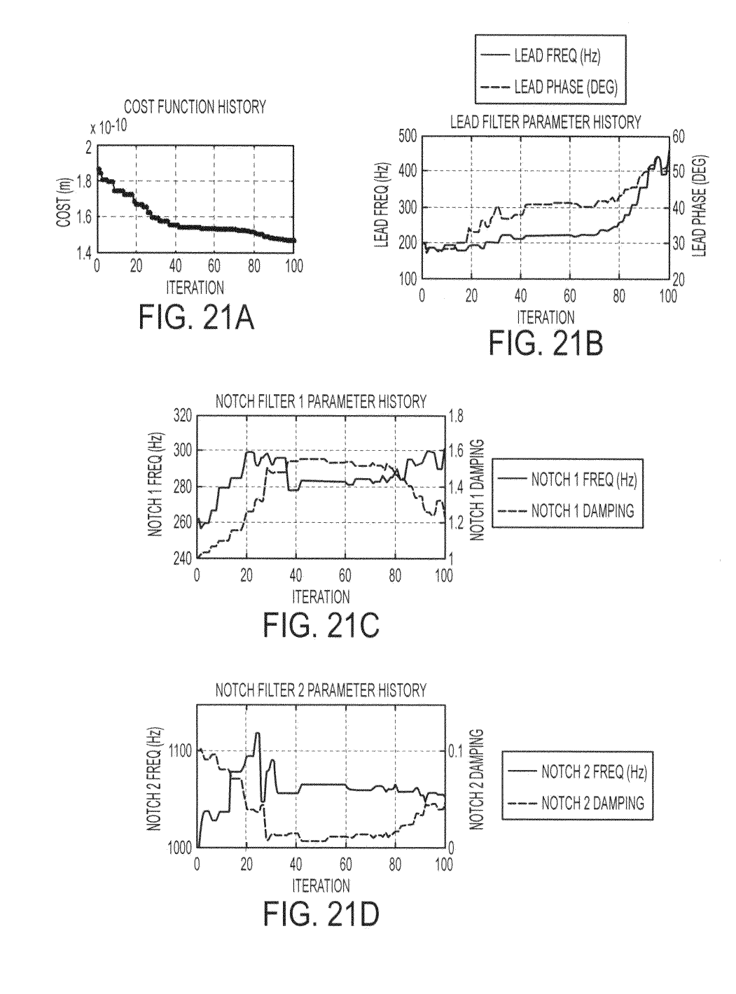

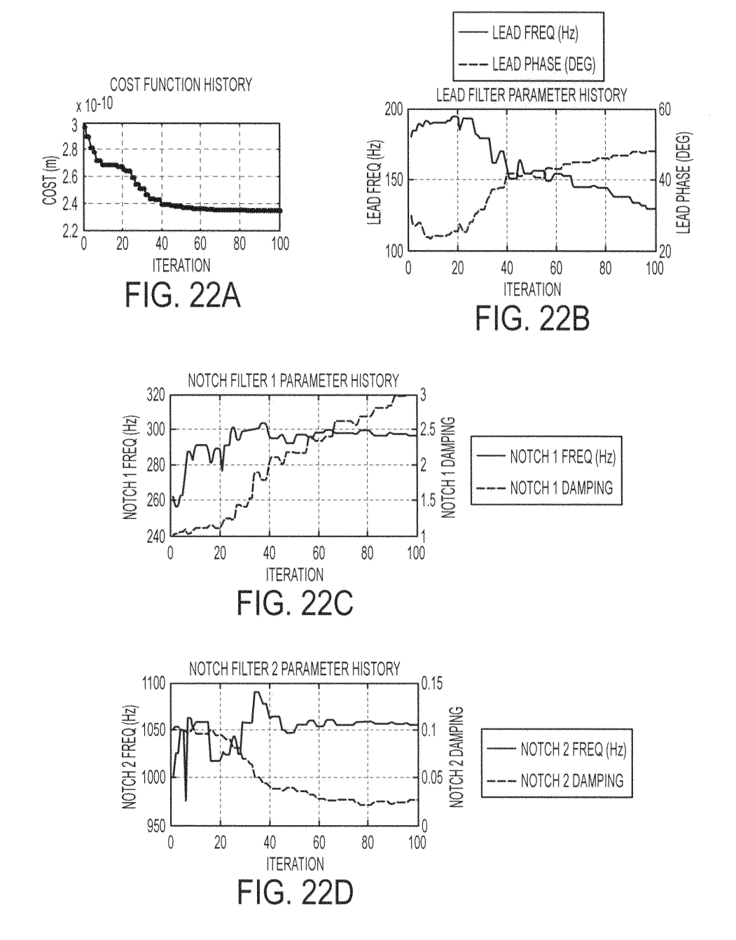

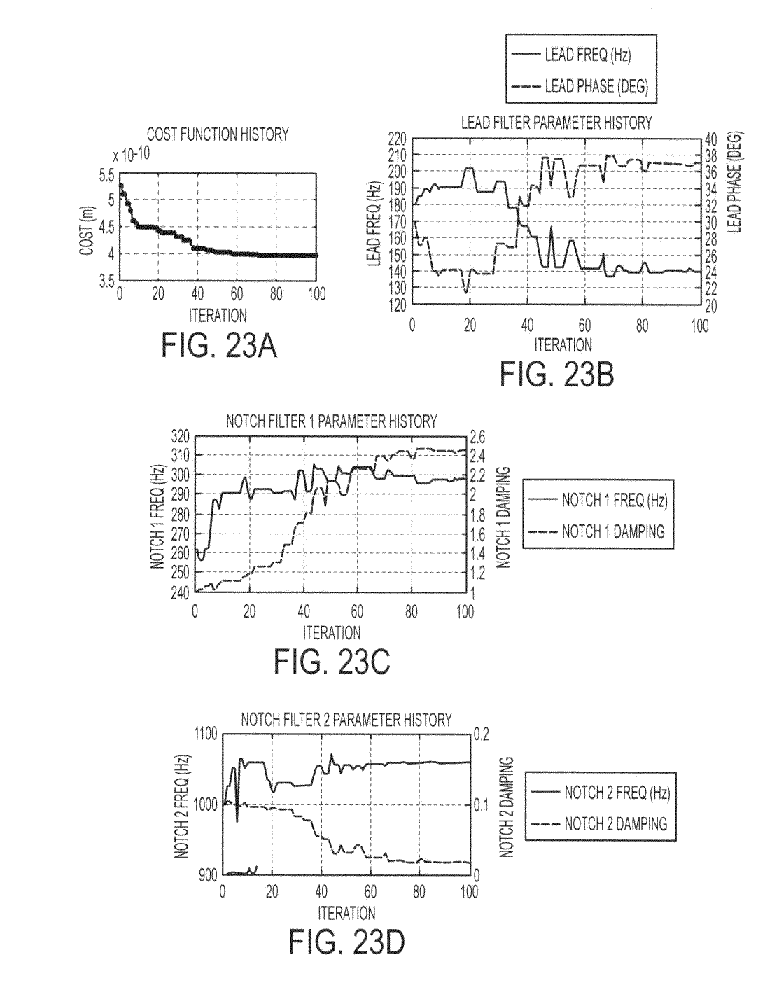

Shown in FIGS. 19A-19D, 20A-20D, 21A-21D, 22A-22D, 23A-23D are respective histories of cost-function and target-filter parameters, as obtained during optimizations performed with various respective MSD weightings. The cost function converged smoothly in all cases. Optimization with lower MSD weightings (β=0.01, 0.05) led to zero damping ratios for the second notch filter, which implies that the second notch may not be needed, especially if MSD is not important.

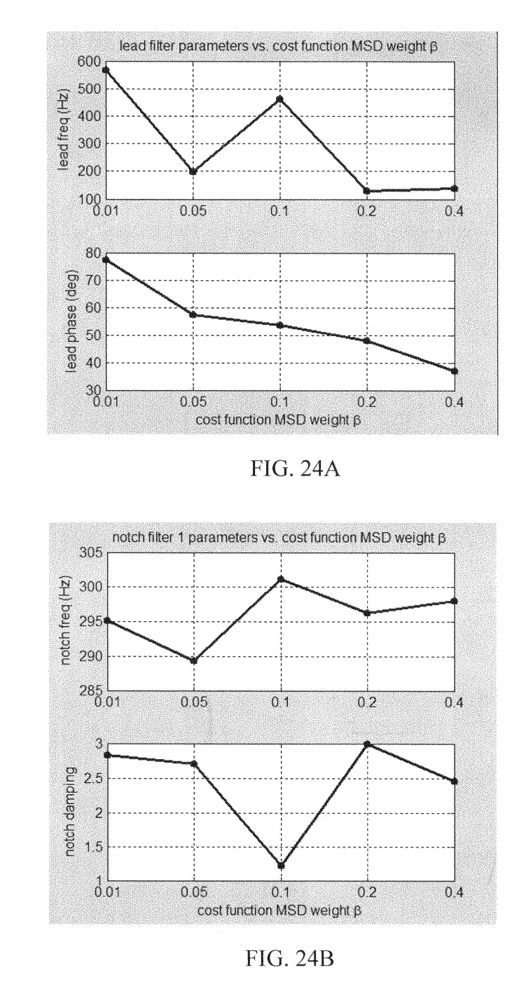

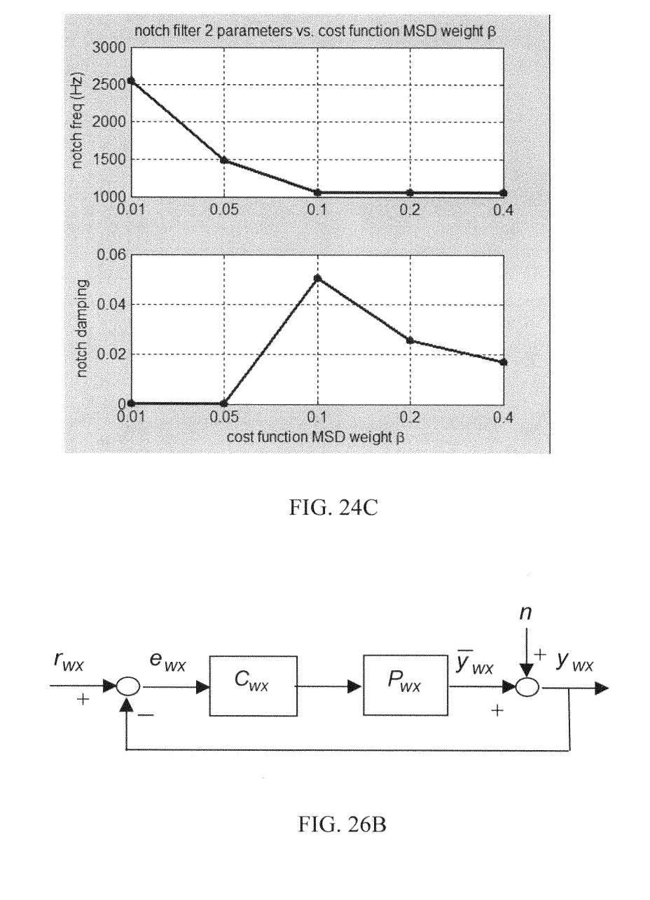

Plotted in FIGS. 24A-24C are converged target-filter parameters as functions of MSD weighting factor β after 100 Simplex iterations.

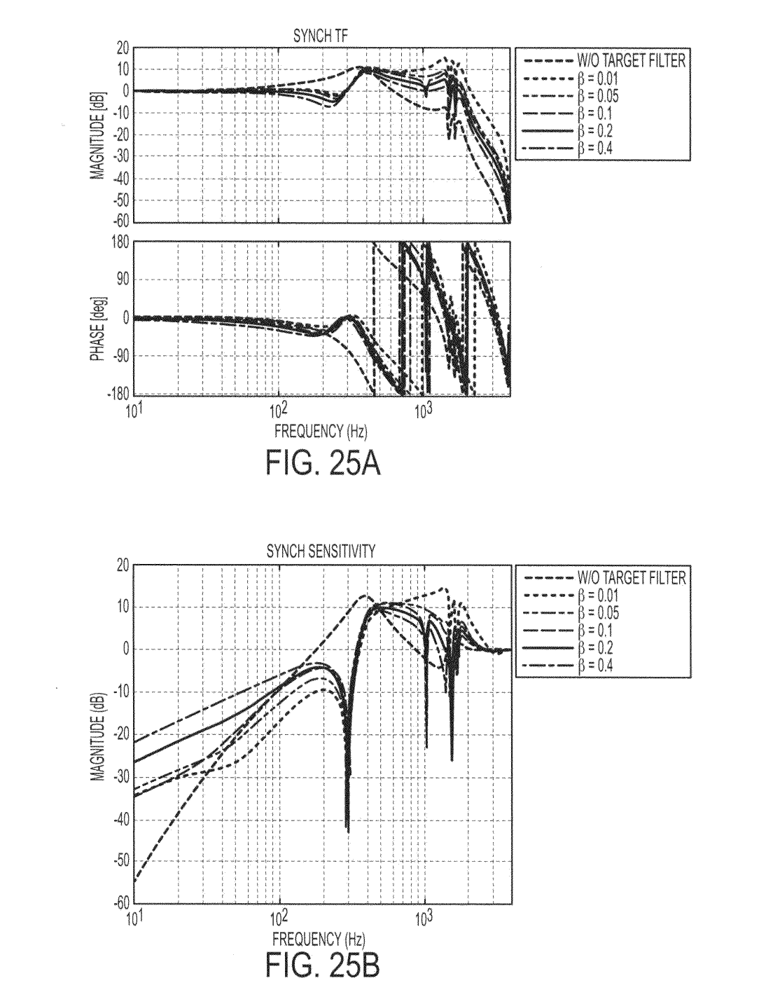

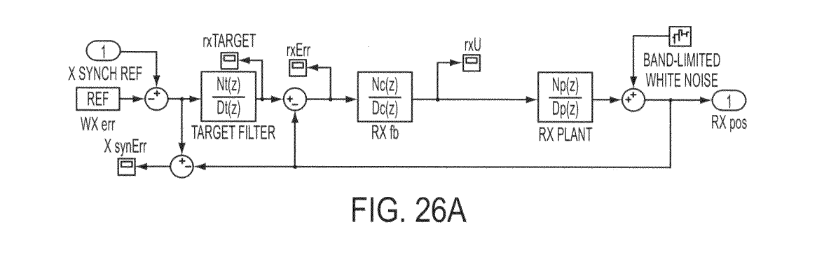

As shown in FIGS. 25A-25B, synchronization-sensitivity frequency responses after 100 Simplex iterations, optimization with lower MSD weighting provides a more aggressive major sensitivity notch for better MA performance.

Therefore, MSD weighting in the cost function determines the optimization direction. The MSD weightings can be adjusted to optimize the target filter to meet a specific set of requirements.

### Active Versus Passive Target Notches; Wafer-Stage Vibrations Versus Measurement Noise

Depending on its use, the target notch filter may be designed either as an active filter or a passive filter. An active target notch filter creates a notch in the synchronization-sensitivity function for the reticle stage for actively tracking the wafer stage at the frequency of interest. In contrast, a passive target notch filter creates a notch in the synchronization transfer function for the reticle stage to ignore the specified-frequency wafer error, so that the reticle stage does not follow it excessively.

In this section, Simplex was used to optimize three synchronization notch filters, as applied to wafer errors at around 250, 700, and 1000 Hz, respectively. Wafer errors of 660 Hz were introduced to simulate actual wafer-stage interferometer-block vibrations. The Simplex method was used for target filter optimization, with a cost function (Equation (13)) of weighted synchronization error MA and MSD. This cost function considers all the Nₑₓₚ exposure data samples in every scan of all Nₛₕₒₜ on a wafer.

$$J = \sqrt{\frac{1}{( 1 + {β}^{2} ) \cdot {N}_{shot} \cdot {N}_{exp}} {\sum }_{i = 1}^{Nshot} {\sum }_{k = 1}^{{N}_{exp}} {MA}^{2} ( k , i ) + {β}^{2} \cdot {MSD}^{2} ( k , i )} \qquad ( 13 )$$

The MSD weighting parameter β in the cost function is used to fine-tune the MA and MSD relative performance.

The particular embodiment of a target filter as utilized here included three notch filters and a lead filter to provide synchronization-sensitivity notches at around 250 Hz, 700 Hz, and 1 kHz, respectively. The eight parameters to be optimized are: frequency of the lead filter (w_{lead}) and phase of the lead filter (θ_{lead), and frequency and damping of the three synchronization-sensitivity notches:}

| Initial | Lower | Upper |
|---|---|---|
| w_{lead} = 180 Hz | 10 Hz | 5 × 10³ Hz |
| θ_{lead} = 30° | 10° | 85° |
| w_{notch, 1} = 250 HZ | 10 Hz | 5 × 10³ Hz |
| d_{notch, 1} = 1 | 1 × 10⁻⁶ | 3 |
| w_{notch, 3} = 700 Hz | 10 Hz | 5 × 10³ Hz |
| d_{notch, 2} = 0.1 | 1 × 10⁻⁶ | 3 |
| w_{notch, 3} = 1000 Hz | 10 Hz | 5 × 10³ Hz |
| d_{notch, 3} = 0.1 | 1 × 10⁻⁶ | 3 |

Two types of target notch filters were evaluated here: (1) an active-notch filter for creating a synchronization-sensitivity notch, and (2) a passive-notch filter for creating a synchronization TF notch. For an active notch, the actual parameters (w₁, w₂, d₁, d₂) desirably are calculated based on the reticle-stage closed-loop transfer function and other synchronization filters. For discrete time implementation, the notch filters desirably are pre-warped at a desired synch-sensitivity notch frequency w_{notch}, rather than at the filter numerator frequency w₁ or the denominator frequency w₂. A constraint w₁=w₂ was imposed to simplify the optimization. For a passive notch, its parameters (w₁, w₂, d₁, d₂) were directly assigned, and the constraint w₁=w₂ was imposed to simplify the optimization.

The first notch filter (250 Hz) was active, and the other two, higher-frequency, notches were either active or passive. In the simulations performed here, for simplicity no ILC was used, and the target notch filter was used to compensate for wafer-error variations. The wafer-error difference exhibited by wafers #1 and #10 of real-machine data (at 625 mm/s scan speed) was used as the input to the target filter. To evaluate the influence of vibrations of the wafer-stage interferometer block (approximately 700 Hz) on synchronization performance, sinusoidal functions of 1 nm and 660 Hz were added to the wafer-stage output position, as illustrated in FIG. 26A. We assumed the 660-Hz vibration of the interferometer block does not affect measurements of the reticle-stage position. FIG. 26B is a control diagram for a simulation of the wafer X-position closed-loop model, with measurement noise.

Due to closed-loop control, the measured X position (y_{wx}) of the wafer and an actual wafer X position ( y̅_{wx}) are different, as described below:

$$\begin{matrix}\frac{{y}_{wx}}{n} = \frac{1}{1 + {P}_{wx} {C}_{wx}} = - \frac{{e}_{wx}}{n} & ( 14 ) \\ \frac{{\overline{y}}_{wx}}{n} = \frac{- {P}_{wx} {C}_{wx}}{1 + {P}_{wx} {C}_{wx}} = - \frac{{\overline{e}}_{wx}}{n} & ( 15 )\end{matrix}$$

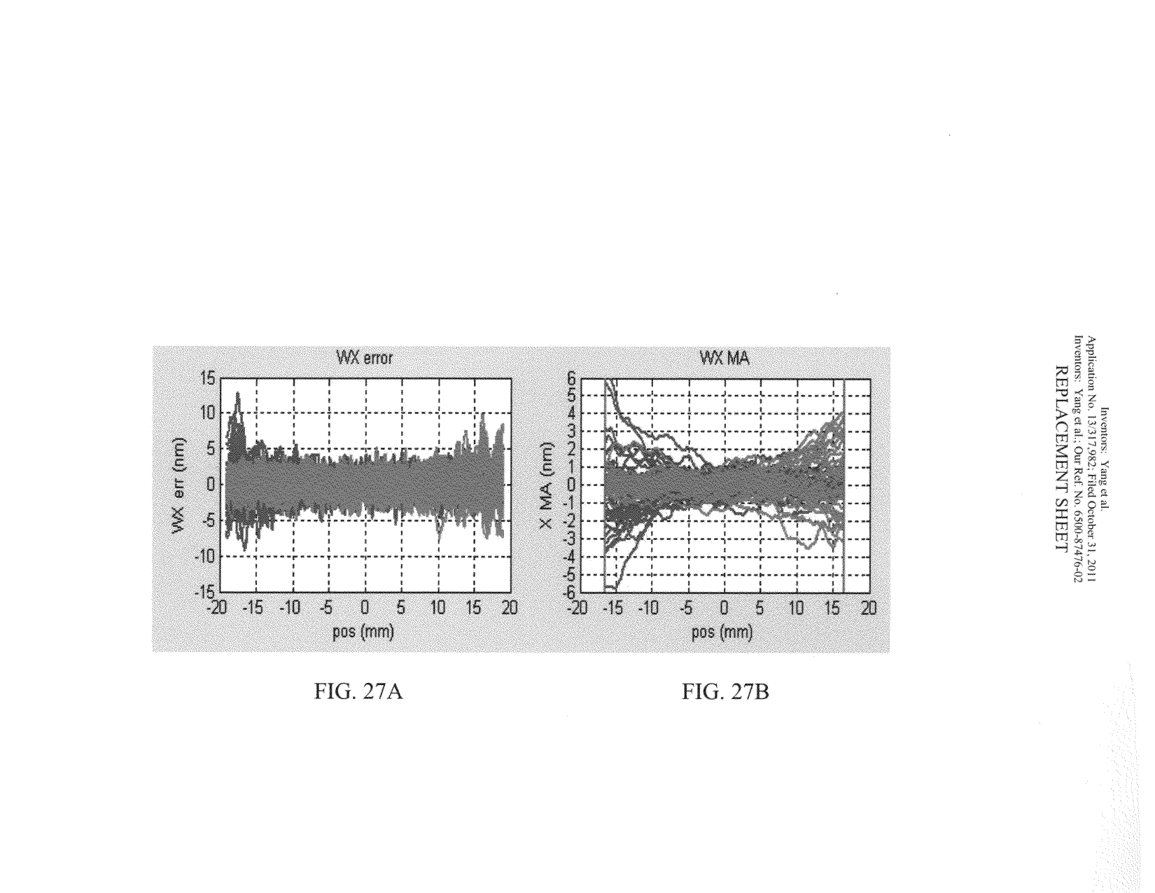

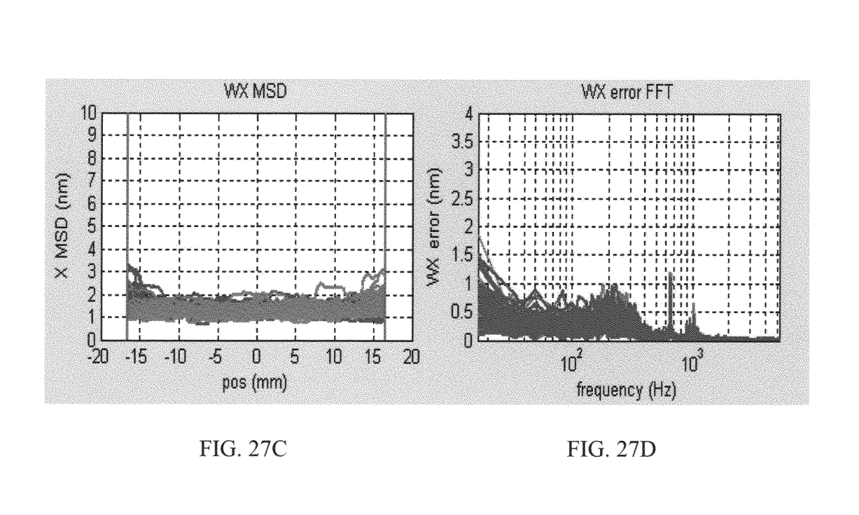

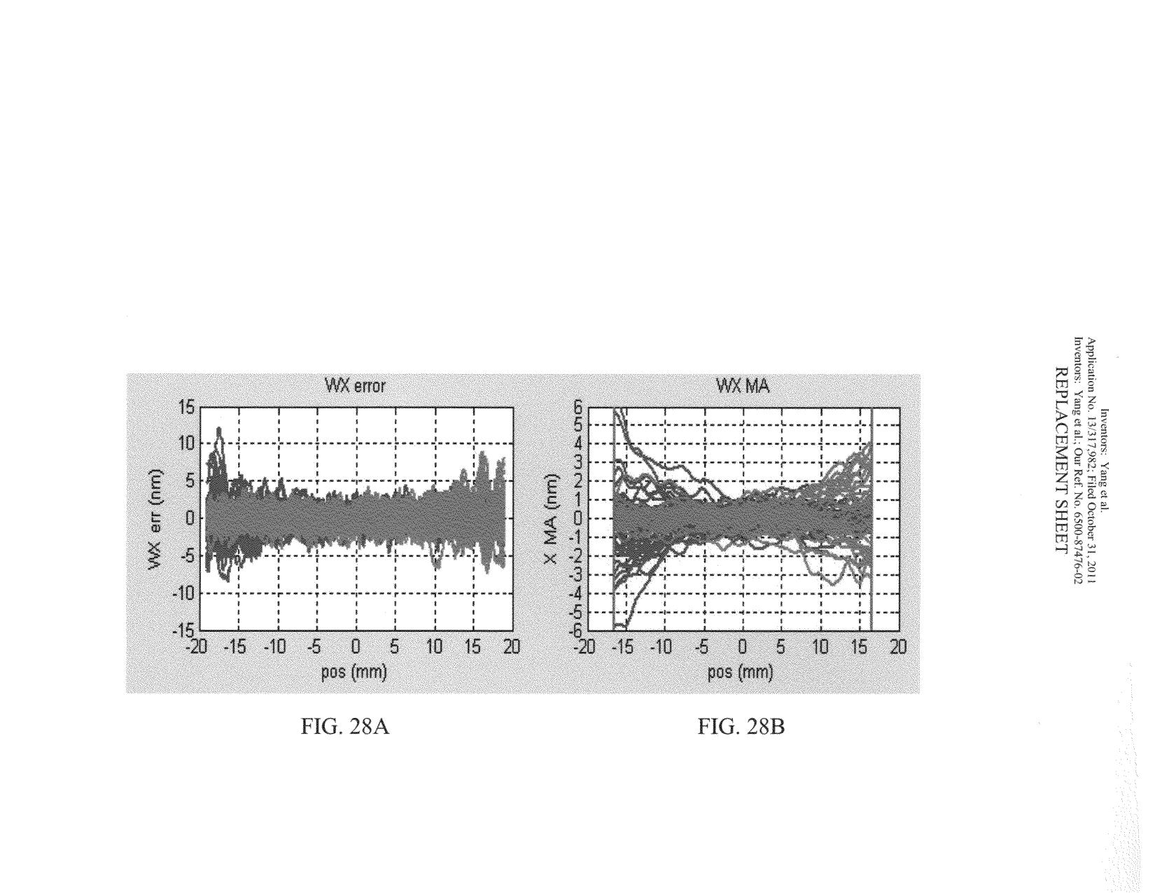

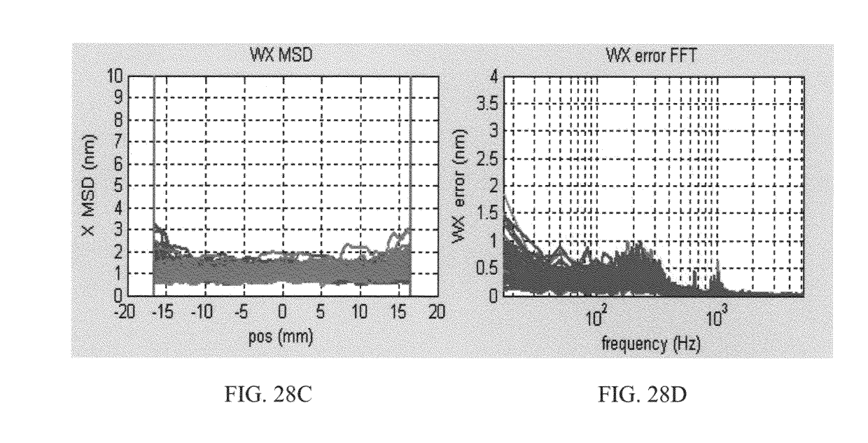

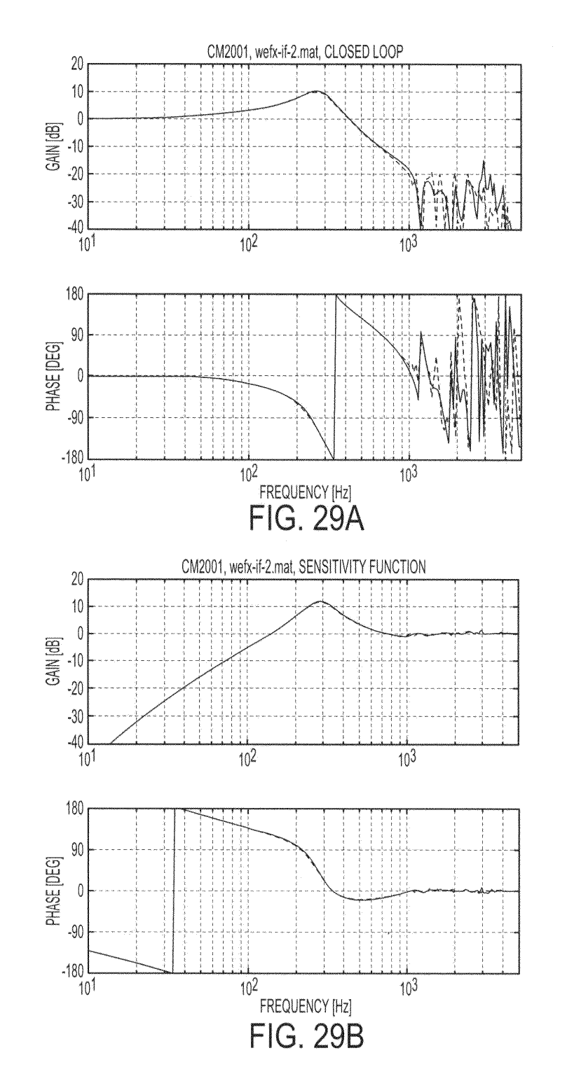

Based on Equations (14) and (15) and the measured WX closed-loop frequency responses described below, it was possible to add artificial 660-Hz vibrations to create the so-called “measured” and “actual” wafer-stage errors (see FIGS. 27A-27D and 28A-28D. The former (FIGS. 27A-27D) was used in the synchronization control, while the latter (FIGS. 28A-28D) was used for checking the actual synchronization error. Plotted in FIGS. 29A and 29B are the WX closed-loop transfer function and sensitivity functions, respectively, which are used in the 660-Hz wafer X-vibration calculation.

With MSD weighting β=0.05 and the same initial target-filter parameters, 100-iteration Simplex optimization produced good MA and MSD performance for every active/passive combination of second/third notches. Here, only the measured synchronization error was used for producing optimization. For analysis purposes, we also calculated the actual synchronization error based on the actual wafer error.

With a passive second notch, the actual 660-Hz synch error was lower than the measurement. In contrast, with an active second notch, the actual 660-Hz error was higher than the measurement. The 660-Hz wafer error has no significant influence on synchronization MA.

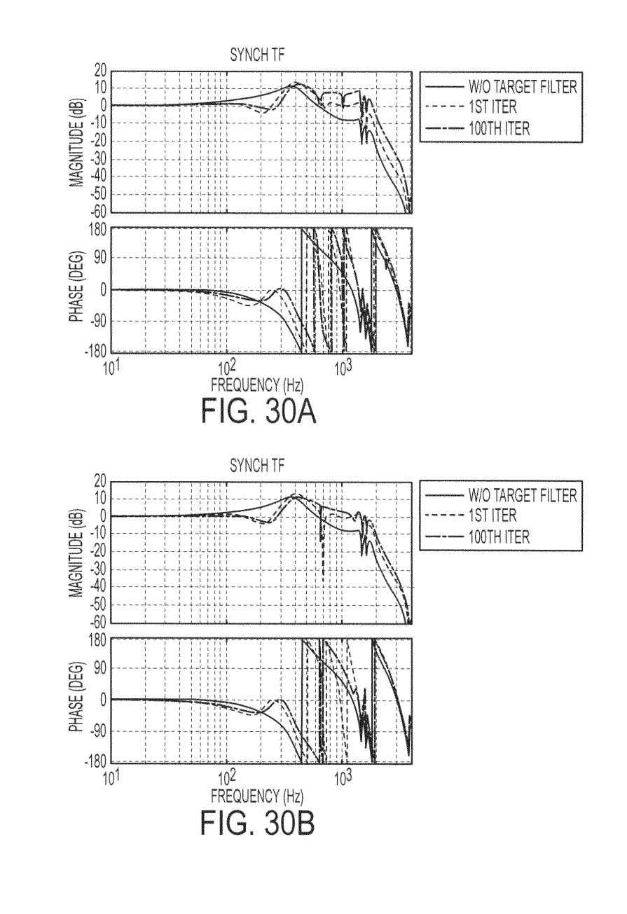

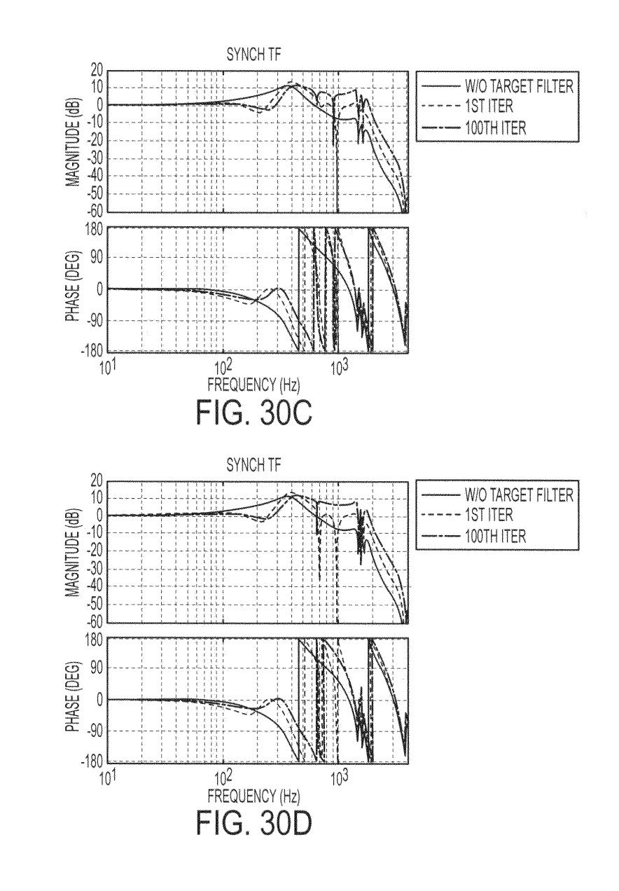

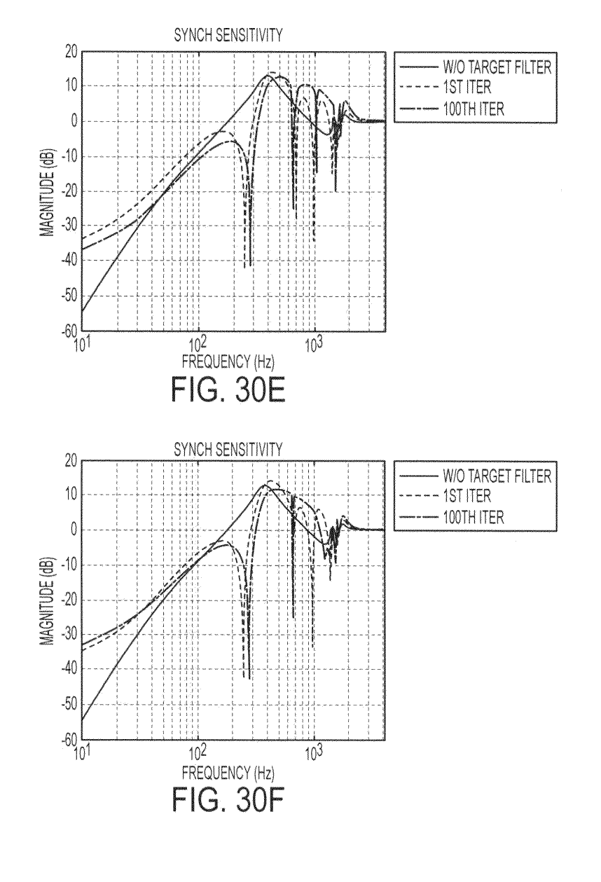

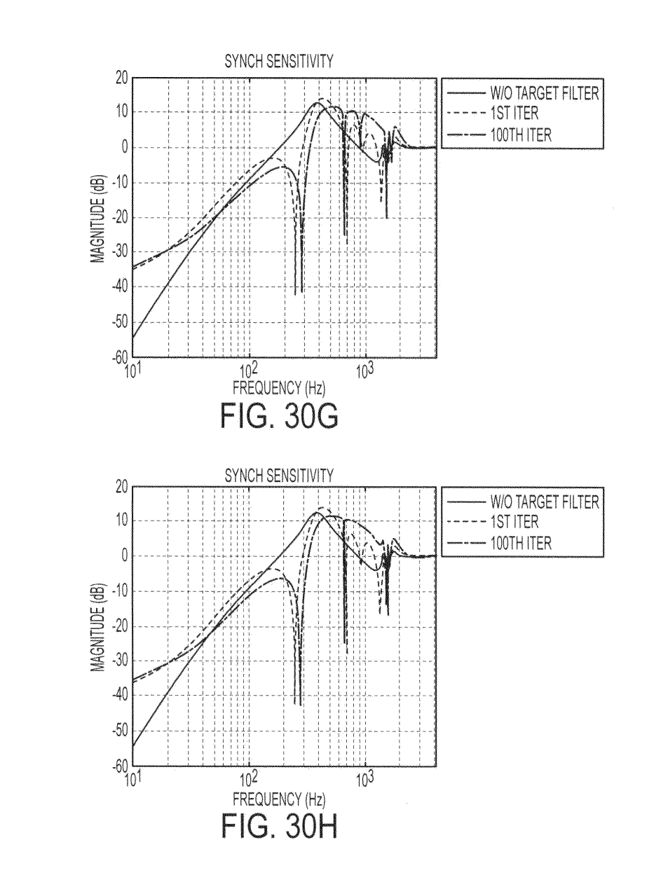

The results of these analyses are shown in FIGS. 30A-30H. These plots also show that active and passive notch filters introduce notches in the synch sensitivity and synch transfer function, respectively.

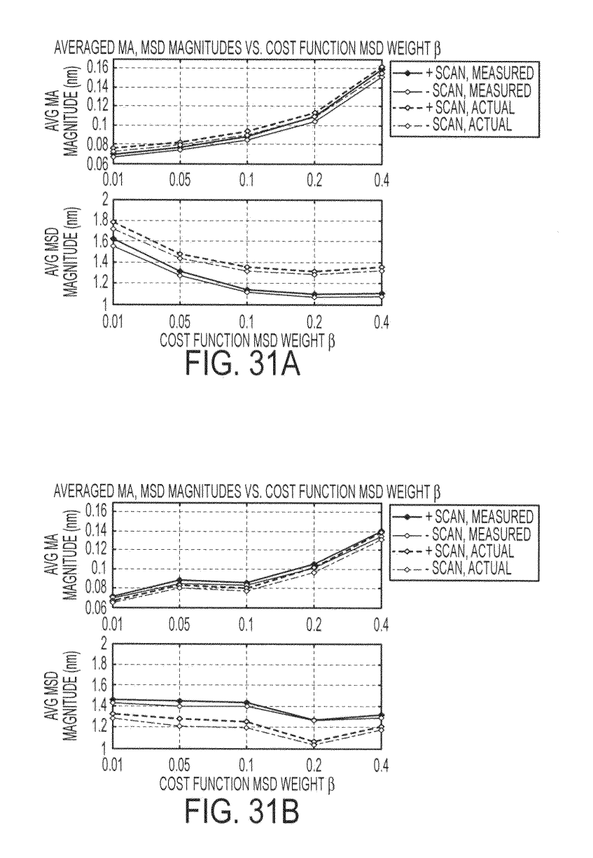

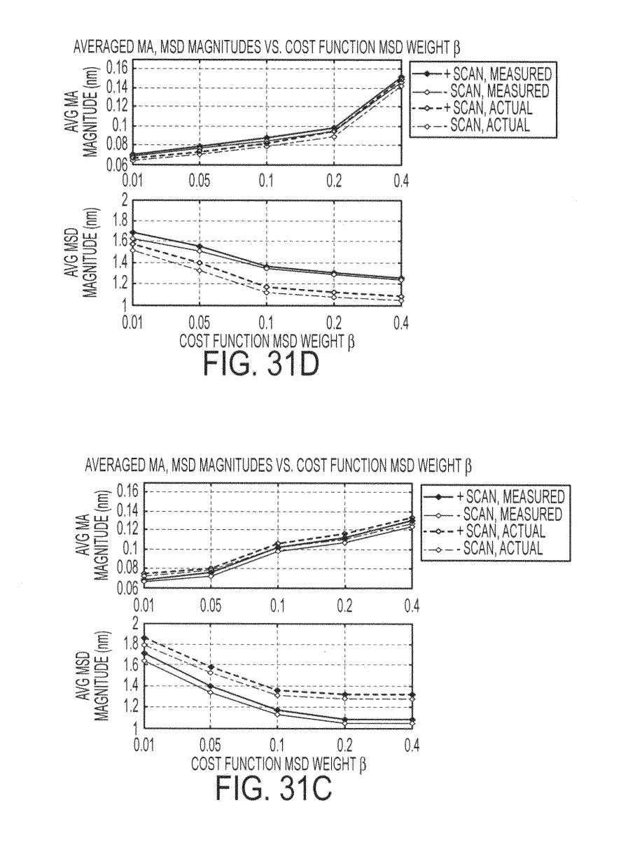

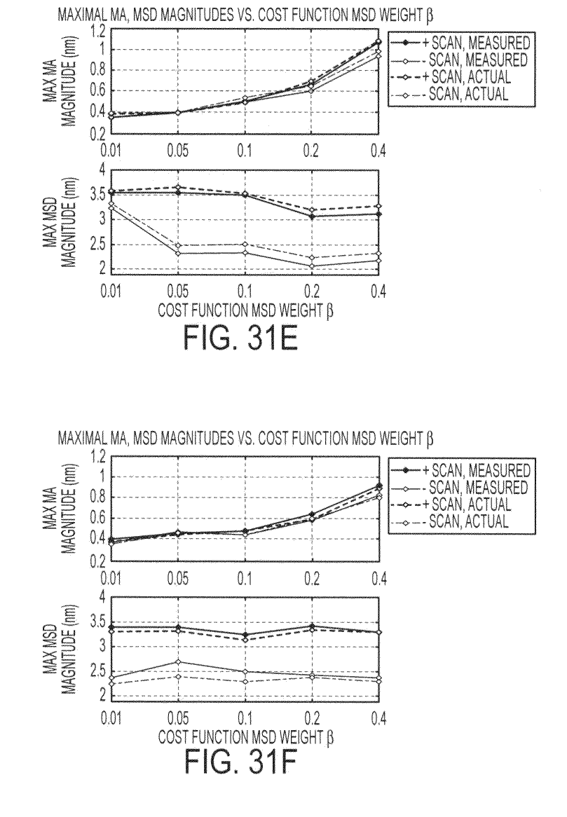

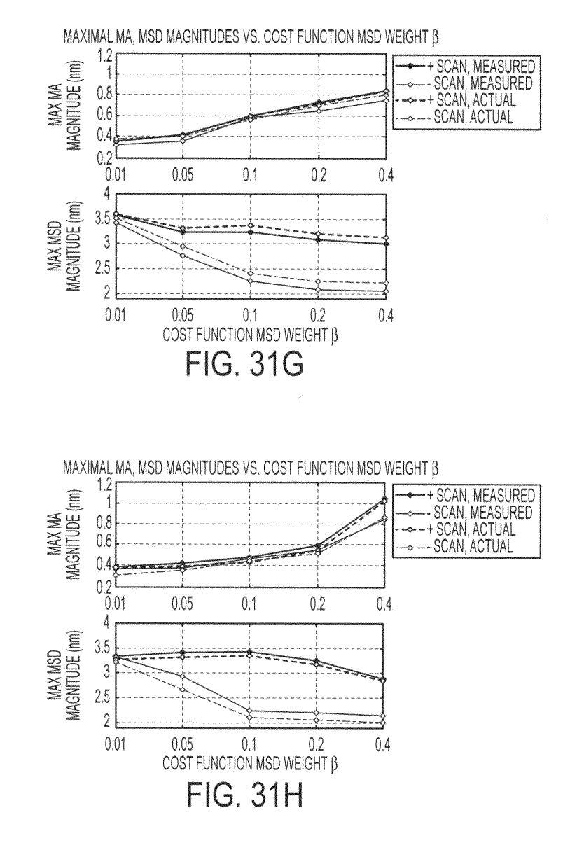

Optimization results were also obtained with various MSD weightings β=0.01, 0.05, 0.1, 0.2, 0.4). The results of these analyses are summarized in FIGS. 31A-31H.

### Precision Systems

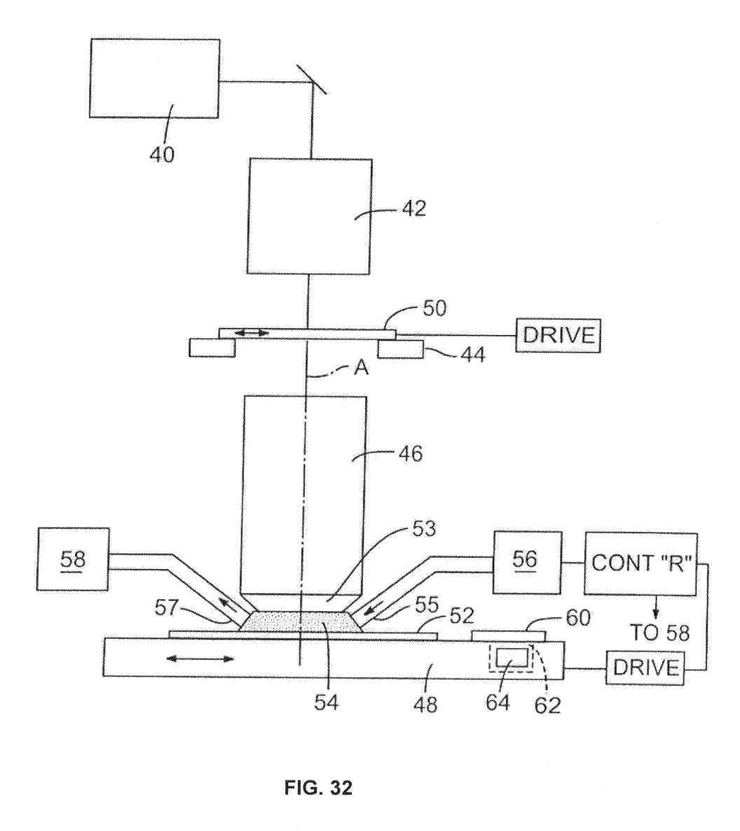

Turning now to FIG. 32, certain features of an immersion lithography system (an exemplary precision system) are shown, namely, a light source 540, an illumination-optical system 542, a reticle stage 544, a projection-optical system 546, and a wafer (substrate) stage 548, all arranged along an optical axis A. The light source 540 is configured to produce a pulsed beam of illumination light, such as DUV light of 248 nm as produced by a KrF excimer laser, DUV light of 193 nm as produced by an ArF excimer laser, or DUV light of 157 nm as produced by an F₂ excimer laser. The illumination-optical system 542 includes an optical integrator and at least one lens that conditions and shapes the illumination beam for illumination of a specified region on a patterned reticle 550 mounted to the reticle stage 544. The pattern as defined on the reticle 550 corresponds to the pattern to be transferred lithographically to a wafer 552 that is held on the wafer stage 548. Lithographic transfer in this system is by projection of an aerial image of the pattern from the reticle 550 to the wafer 552 using the projection-optical system 546. The projection-optical system 546 typically comprises many individual optical elements (not detailed) that project the image at a specified demagnification ratio (e.g., 1/4 or 1/5) on the wafer 552. So as to be imprintable, the wafer surface is coated with a layer of a suitable exposure-sensitive material termed a “resist.”

The reticle stage 544 is configured to move the reticle 550 in the X-direction, Y-direction, and rotationally about the Z-axis. To such end, the reticle stage is equipped with one or more linear motors having cooled coils as described herein. The two-dimensional position and orientation of the reticle 550 on the reticle stage 544 are detected by a laser interferometer (not shown) in real time, and positioning of the reticle 550 is effected by a main control unit on the basis of the detection thus made.

The wafer 552 is held by a wafer holder (“chuck,” not shown) on the wafer stage 548. The wafer stage 548 includes a mechanism (not shown) for controlling and adjusting, as required, the focusing position (along the Z-axis) and the tilting angle of the wafer 552. The wafer stage 548 also includes electromagnetic actuators (e.g., linear motors or a planar motor, or both) for moving the wafer in the X-Y plane substantially parallel to the image-formation surface of the projection-optical system 546. These actuators desirably comprise linear motors, one more planar motors, or both.

The wafer stage 548 also includes mechanisms for adjusting the tilting angle of the wafer 552 by an auto-focusing and auto-leveling method. Thus, the wafer stage serves to align the wafer surface with the image surface of the projection-optical system. The two-dimensional position and orientation of the wafer are monitored in real time by another laser interferometer (not shown). Control data based on the results of this monitoring are transmitted from the main control unit to a drive circuits for driving the wafer stage. During exposure, the light passing through the projection-optical system is made to move in a sequential manner from one location to another on the wafer, according to the pattern on the reticle in a step-and-repeat or step-and-scan manner.

The projection-optical system 546 normally comprises many lens elements that work cooperatively to form the exposure image on the resist-coated surface of the wafer 552. For convenience, the most distal optical element (i.e., closest to the wafer surface) is an objective lens 553. Since the depicted system is an immersion lithography system, it includes an immersion liquid 554 situated between the objective lens 553 and the surface of the wafer 552. As discussed above, the immersion liquid 554 is of a specified type. The immersion liquid is present at least while the pattern image of the reticle is being exposed onto the wafer.

The immersion liquid 554 is provided from a liquid-supply unit 556 that may comprise a tank, a pump, and a temperature regulator (not individually shown). The liquid 554 is gently discharged by a nozzle mechanism 555 into the gap between the objective lens 553 and the wafer surface. A liquid-recovery system 558 includes a recovery nozzle 57 that removes liquid from the gap as the supply 56 provides fresh liquid 554. As a result, a substantially constant volume of continuously replaced immersion liquid 554 is provided between the objective lens 553 and the wafer surface. The temperature of the liquid is regulated to be approximately the same as the temperature inside the chamber in which the lithography system itself is disposed.

Also shown is a sensor window 560 extending across a recess 562, defined in the wafer stage 548, in which a sensor 564 is located. Thus, the window 560 sequesters the sensor 564 in the recess 562. Movement of the wafer stage 548 so as to place the window 560 beneath the objective lens 553, with continuous replacement of the immersion fluid 554, allows a beam passing through the projection-optical system 546 to transmit through the immersion fluid and the window 560 to the sensor 564.

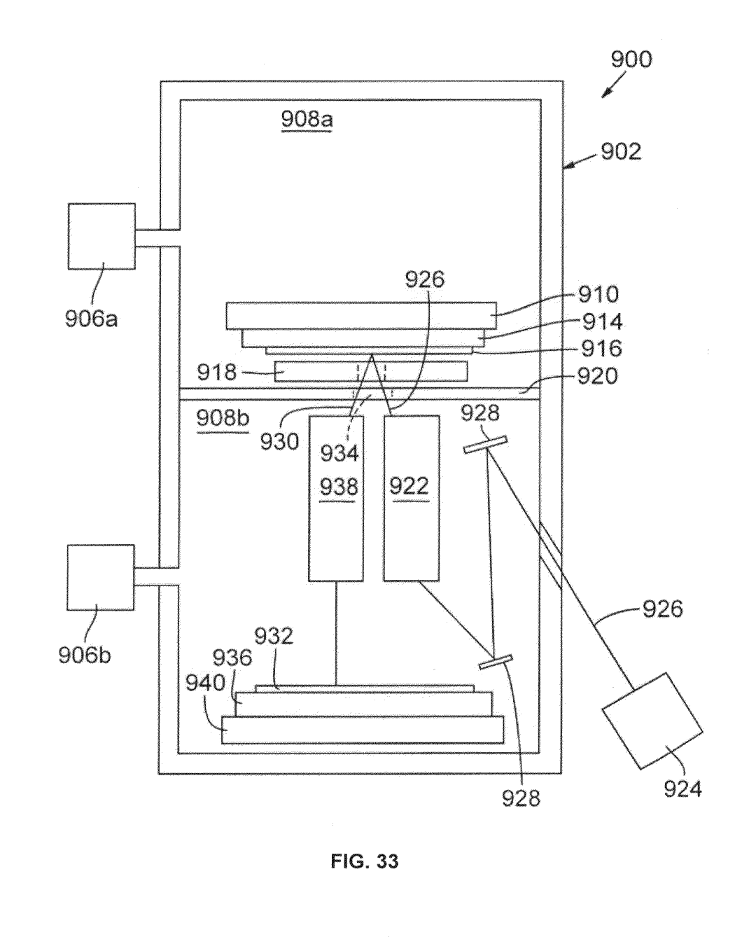

Referring now to FIG. 33, an alternative embodiment of a precision system that can include one or more electromagnetic actuators having actively cooled coils as described herein is an EUVL system 900, as a representative precision system incorporating an electromagnetic actuator as described herein, is shown. The depicted system 900 comprises a vacuum chamber 902 including vacuum pumps 906a, 906b that are arranged to enable desired vacuum levels to be established and maintained within respective chambers 908a, 908b of the vacuum chamber 902. For example, the vacuum pump 906a maintains a vacuum level of approximately 50 mTorr in the upper chamber (reticle chamber) 908a, and the vacuum pump 906b maintains a vacuum level of less than approximately 1 mTorr in the lower chamber (optical chamber) 908b. The two chambers 908a, 908b are separated from each other by a barrier wall 920. Various components of the EUVL system 900 are not shown, for ease of discussion, although it will be appreciated that the EUVL system 900 can include components such as a reaction frame, a vibration-isolation mechanism, various actuators, and various controllers.

An EUV reticle 916 is held by a reticle chuck 914 coupled to a reticle stage 910. The reticle stage 910 holds the reticle 916 and allows the reticle to be moved laterally in a scanning manner, for example, during use of the reticle for making lithographic exposures. Between the reticle 916 and the barrier wall 920 is a blind apparatus. An illumination source 924 produces an EUV illumination beam 926 that enters the optical chamber 908b and reflects from one or more mirrors 928 and through an illumination-optical system 922 to illuminate a desired location on the reticle 916. As the illumination beam 926 reflects from the reticle 916, the beam is “patterned” by the pattern portion actually being illuminated on the reticle. The barrier wall 920 serves as a differential-pressure barrier and can serve as a reticle shield that protects the reticle 916 from particulate contamination during use. The barrier wall 920 defines an aperture 934 through which the illumination beam 926 may illuminate the desired region of the reticle 916. The incident illumination beam 926 on the reticle 916 becomes patterned by interaction with pattern-defining elements on the reticle, and the resulting patterned beam 930 propagates generally downward through a projection-optical system 938 onto the surface of a wafer 932 held by a wafer chuck 936 on a wafer stage 940 that performs scanning motions of the wafer during exposure. Hence, images of the reticle pattern are projected onto the wafer 932.

The wafer stage 940 can include (not detailed) a positioning stage that may be driven by a planar motor or one or more linear motors, for example, and a wafer table that is magnetically coupled to the positioning stage using an E1-core actuator, for example. The wafer chuck 936 is coupled to the wafer table, and may be levitated relative to the wafer table by one or more voice-coil motors, for example. If the positioning stage is driven by a planar motor, the planar motor typically utilizes respective electromagnetic forces generated by magnets and corresponding armature coils arranged in two dimensions. The positioning stage is configured to move in multiple degrees of freedom of motion, e.g., three to six degrees of freedom, to allow the wafer 932 to be positioned at a desired position and orientation relative to the projection-optical system 938 and the reticle 916.

An EUVL system including the above-described EUV-source and illumination-optical system can be constructed by assembling various assemblies and subsystems in a manner ensuring that prescribed standards of mechanical accuracy, electrical accuracy, and optical accuracy are met and maintained. To establish these standards before, during, and after assembly, various subsystems (especially the illumination-optical system 922 and projection-optical system 938) are assessed and adjusted as required to achieve the specified accuracy standards. Similar assessments and adjustments are performed as required of the mechanical and electrical subsystems and assemblies. Assembly of the various subsystems and assemblies includes the creation of optical and mechanical interfaces, electrical interconnections, and plumbing interconnections as required between assemblies and subsystems. After assembling the EUVL system, further assessments, calibrations, and adjustments are made as required to ensure attainment of specified system accuracy and precision of operation. To maintain certain standards of cleanliness and avoidance of contamination, the EUVL system (as well as certain subsystems and assemblies of the system) are assembled in a clean room or the like in which particulate contamination, temperature, and humidity are controlled.

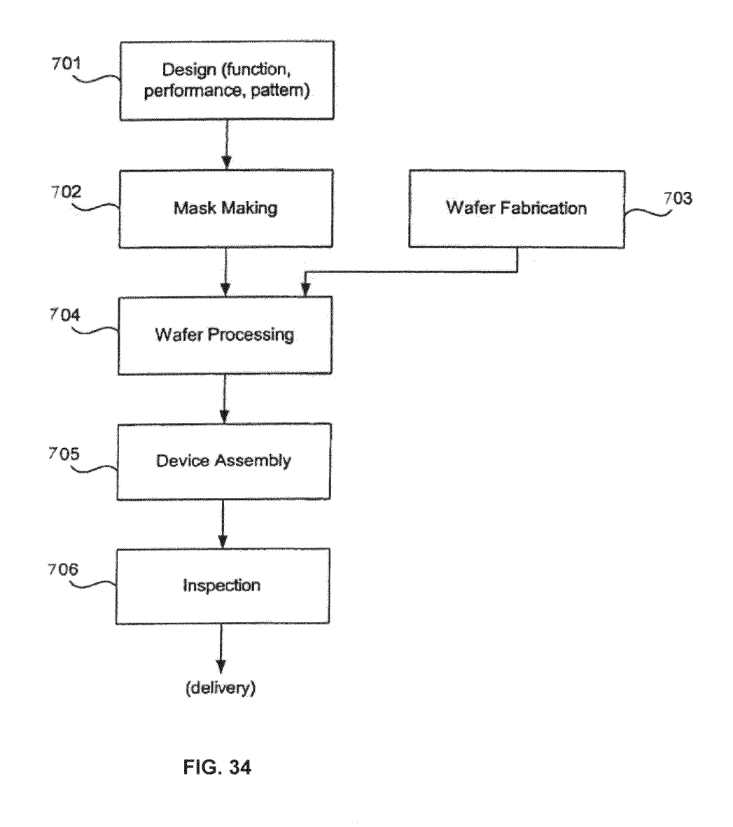

Semiconductor devices can be fabricated by processes including microlithography steps performed using a microlithography system as described above. Referring to FIG. 34, in step 701 the function and performance characteristics of the semiconductor device are designed. In step 702 a reticle (“mask”) defining the desired pattern is designed and fabricated according to the previous design step. Meanwhile, in step 703, a substrate (wafer) is fabricated and coated with a suitable resist. In step 704 (“wafer processing”) the reticle pattern designed in step 702 is exposed onto the surface of the substrate using the microlithography system. In step 705 the semiconductor device is assembled (including “dicing” by which individual devices or “chips” are cut from the wafer, “bonding” by which wires are bonded to particular locations on the chips, and “packaging” by which the devices are enclosed in appropriate packages for use). In step 706 the assembled devices are tested and inspected.

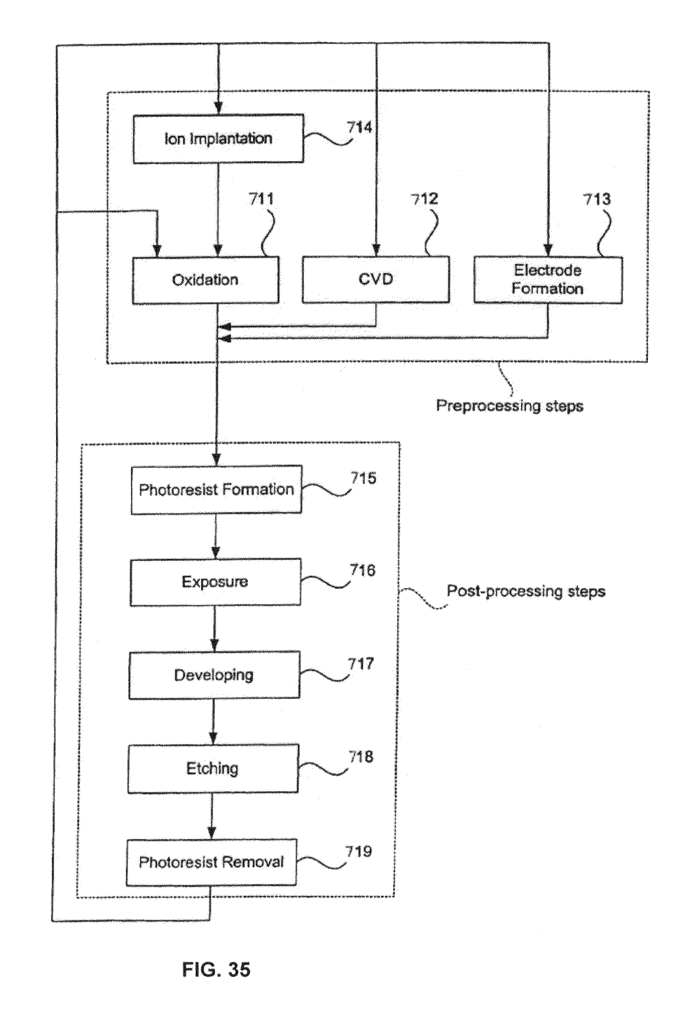

Representative details of a wafer-processing process including a microlithography step are shown in FIG. 35. In step 711 (“oxidation”) the wafer surface is oxidized. In step 712 (“CVD”) an insulative layer is formed on the wafer surface by chemical-vapor deposition. In step 713 (electrode formation) electrodes are formed on the wafer surface by vapor deposition, for example. In step 714 (“ion implantation”) ions are implanted in the wafer surface. These steps 711-714 constitute representative “pre-processing” steps for wafers, and selections are made at each step according to processing requirements.

At each stage of wafer processing, when the pre-processing steps have been completed, the following “post-processing” steps are implemented. A first post-process step is step 715 (“photoresist formation”) in which a suitable resist is applied to the surface of the wafer. Next, in step 716 (“exposure”), the microlithography system described above is used for lithographically transferring a pattern from the reticle to the resist layer on the wafer. In step 717 (“developing”) the exposed resist on the wafer is developed to form a usable mask pattern, corresponding to the resist pattern, in the resist on the wafer. In step 718 (“etching”), regions not covered by developed resist (i.e., exposed material surfaces) are etched away to a controlled depth. In step 719 (“photoresist removal”), residual developed resist is removed (“stripped”) from the wafer.

Formation of multiple interconnected layers of circuit patterns on the wafer is achieved by repeating the pre-processing and post-processing steps as required. Generally, a set of pre-processing and post-processing steps are conducted to form each layer.

Whereas the invention has been described in connection with representative embodiments, it will be understood that it is not limited to those embodiments. On the contrary, it is intended to encompass all alternatives, modifications, and equivalents as may be included within the spirit and scope of the invention as defined by the appended claims.

What is claimed is:

1. A control system for controlling motion of a first movable body along a first trajectory in coordination with motion of a second movable body along a second trajectory, the system comprising:
a first controller providing first driving commands to the first movable body;
a second controller providing second driving commands to the second movable body;
a first control loop, associated with the first controller, providing feedback to the first controller of position-error data regarding the first movable body;
a second control loop, associated with the second controller, providing feedback to the second controller of position-error data regarding the second movable body; and
a synchronization target filter coupled to the first and second control loops, the target filter and first controller moving the first movable body in a manner that tracks the position-error data of the second movable body at one or more frequencies of interest.

2. The system of claim 1, wherein the synchronization target filter connects the second control loop to outside the first control loop.

3. The system of claim 1, further comprising a first iterative learning controller connected to the first control loop.

4. The system of claim 3, further comprising a second iterative learning controller connected to the second control loop.

5. The system of claim 1, further comprising:
a first iterative learning controller associated with the first control loop;
a second iterative learning controller associated with the second control loop.

6. The system of claim 5, wherein:
the first control loop is a closed loop; and
the synchronization target filter is connected between the second iterative learning controller and the first control loop.

7. The system of claim 5, wherein:
the first iterative learning controller includes an input connected to an output of the first control loop and an output connected to the first control loop;
the second control loop is a closed loop; and
the second iterative learning controller is connected to the second control loop.

8. The system of claim 7, further comprising:
a first feedback filter connected between the first controller and the connection of the first iterative learning controller to the first control loop; and
a second feedback filter connected between the first controller and the connection of the second iterative learning controller to the second closed loop.

9. The system of claim 5, wherein the second iterative learning controller is configured to learn synchronization error of the second movable body relative to the first movable body.

10. The system of claim 1, wherein the synchronization target filter includes a phase lead filter and at least one notch filter for a respective frequency of interest.

11. The system of claim 10, wherein at least one notch filter of the target filter is active.

12. The system of claim 10, wherein at least one notch filter of the target filter is passive.

13. The system of claim 10, wherein the synchronization target filter includes n notch filters, wherein n is an integer, and each notch filter corresponds to a respective frequency of interest.

14. The system of claim 13, wherein:
n≧2; and
at least one respective notch filter is active and at least one respective notch filter is passive.

15. The system of claim 1, wherein the synchronization target filter has a cost function of synchronization-error MA and MSD.

16. The system of claim 1, wherein:
the first movable body comprises a movable portion of a first stage; and
the second movable body comprises a movable portion of a second stage that moves in coordination with motion of the first stage.

17. A control system providing synchronous motion of a first movable body and a second movable body, the system comprising:
first and second actuators configured to move first and second movable bodies, respectively;
first and second controllers providing command outputs to the first and second actuators, respectively;
first and second control loops providing feedback-control data regarding positions of the first and second movable bodies, respectively, to the first and second controllers;
first and second iterative learning controllers connected to the first and second control loops, respectively; and
a synchronization target filter connected outside the first closed loop and to the second closed loop, the synchronization target filter tracking motions of the first and second actuators and to cause the first controller to move the first actuator synchronously with motion of the second movable stage, at one or more frequencies of interest.

18. The system of claim 17, wherein:
the first actuator is associated with a first movable stage; and
the second actuator is associated with a second movable stage.

19. The control system of claim 17, wherein the synchronization target filter tracks the motions according to first-actuator closed-loop dynamics.

20. The control system of claim 17, wherein the target filter comprises at least one notch filter, corresponding to a respective notch frequency of interest, and at least one phase-lead filter.

21. The control system of claim 17, wherein the target filter produces optimized parameters, for controlling actuator motions, using a cost function of synchronization-error MA and MSD.

22. A method for reducing a synchronization error of motion of a first movable body coordinated with motion of a second movable body, the method comprising:
driving the first movable body along a first trajectory;
driving the second movable body along a second trajectory in coordination with driving the first movable body along the first trajectory;
controlling the driving of the first movable body by a first iterative learning control (ILC) performed on a first closed feedback loop coupled to the first movable body;
controlling the driving of the second movable body in coordination with the driving of the first movable body, the controlling being by a second iterative learning control (ILC) coupled to second feedback loop;
determining a positional error of the second movable body relative to a position of the first movable body, the positional error indicating a corresponding synchronization error of the driving of the first movable body relative to the driving of the second movable body in association with at least one frequency; and
using a synchronization target filter connected between the second ILC and the first closed feedback loop, reducing the synchronization error associated with the at least one frequency, thereby causing the driving of the first movable body to track the positional error of the second movable body at the at least one frequency.

23. The method of claim 22, further comprising connecting the synchronization target filter between the second ILC and outside the first closed feedback loop.

24. A synchronization target filter, programmed according to a cost function of weighted synchronization error MA and MSD.

25. The filter of claim 24, programmed according to a cost function of:
$$J = \sqrt{\frac{1}{( 1 + {β}^{2} ) \cdot {N}_{shot} \cdot {N}_{exp}} {\sum }_{i = 1}^{Nshot} {\sum }_{k = 1}^{{N}_{exp}} {MA}^{2} ( k , i ) + {β}^{2} \cdot {MSD}^{2} ( k , i )}$$
of weighted synchronization error MA and MSD over all Nₑₓₚ exposure data samples in every scan of all Nₛₕₒₜ on a wafer, wherein β is a MSD weighting parameter.

26. A precision system, comprising:
a first movable body;
a second movable body; and
a control system for controlling motion of the first movable body along a first trajectory in coordination with motion of the second movable body along a second trajectory, the control system comprising
a first controller that produces first driving commands and that is connected to deliver the first driving commands to the first movable body;
a second controller that produces second driving commands and that is connected to deliver the second driving commands to the second movable body;
a first control loop associated with the first controller, the first control loop including feedback to the first controller of position-error data regarding the first movable body;
a second control loop associated with the second controller, the second control loop including feedback to the second controller of position-error data regarding the second movable body; and
a synchronization target filter connecting the second control loop to outside the first control loop, the target filter being configured to cause the first controller to move the first movable body in a manner that tracks the position-error data of the second movable body at one or more frequencies of interest.

27. The precision system of claim 26, wherein:
the first movable body is a reticle on a reticle stage; and
the second movable body is a wafer on a wafer stage.

28. The precision system of claim 27, further comprising an exposure optical system situated between the reticle stage and the wafer stage.

29. A two-stage precision system, comprising:
a first stage;
a second stage coupled to the first stage to produce a coordinated movement of the first and second stages with each other;
a control system that controls motion of the first stage along a first trajectory in coordination with motion of the second stage along a second trajectory, the system comprising
a first controller that produces first driving commands and that is connected to deliver the first driving commands to the first stage;
a second controller that produces second driving commands and that is connected to deliver the second driving commands to the second stage;
a first control loop associated with the first controller, the first control loop providing feedback to the first controller of position-error data regarding the first stage;
a second control loop associated with the second controller, the second control loop providing feedback to the second controller of position-error data regarding the second stage; and
a synchronization target filter connecting the second control loop to outside the first control loop, the target filter causing the first controller to move the first stage in a manner that tracks the position-error data of the second stage at one or more frequencies of interest.

30. The system of claim 29, wherein:
the first stage is a reticle stage; and
the second stage is wafer stage.

31. A method for controlling synchronous motion of a first stage and a second stage relative to each other in a precision system, the method comprising:
driving the first stage along a first trajectory;
driving the second stage along a second trajectory in coordination with driving the first stage along the first trajectory;
controlling the driving of the first stage by a first iterative learning control (ILC) performed on a first closed feedback loop connected to the first stage;
determining a positional error of the second stage relative to a position of the first stage, the positional error indicating a corresponding synchronization error of the driving of the first stage relative to the driving of the stage in association with at least one frequency; and
using a synchronization target filter connected between the second ILC and outside the first closed feedback loop, reducing the synchronization error associated with the at least one frequency, thereby causing the driving of the first stage to track the positional error of the second stage at the at least one frequency.

32. The method of claim 31, further comprising controlling the driving of the second stage in coordination with the driving of the first stage using a second iterative learning control (ILC) on a second feedback loop connected to the second stage.

33. The method of claim 32, in which the first stage is a reticle stage and the second stage is a wafer stage.

34. A precision system: comprising:
a first body that is movable along a first trajectory in coordination with motion of a second movable body along a second trajectory; and
a control system as recited in claim 1 coupled to and controlling motion of the first and second movable bodies.

35. The precision system of claim 34 configured as a microlithography system, in which the first movable body is a substrate stage and the second movable body is a reticle stage.
